(19) United States
(12) Patent Application Publication
(10) Pub. No.: US 2025/0257703 A1
(43) Pub. Date: Aug. 14, 2025

(54) ENHANCED FUEL MIXING SYSTEMS FOR DIRECT INJECTED NATURAL GAS ENGINES, AND DEVICES AND METHODS THEREOF

(71) Applicant: Radical Combustion Technologies, LLC, Vienna, VA (US)

(72) Inventors: Daniel B. OLSEN, Fort Collins, CO (US); James J. MCCOY, JR., Conroe, TX (US); Nathan P. HOFFENBECKER, Loveland, CO (US); Jack D. MACDONALD, Fort Collins, CO (US); Nelson XIE, Fort Collins, CO (US); Michael J. MANFREDI, Vienna, VA (US)

(21) Appl. No.: 19/171,038

(22) Filed: Apr. 4, 2025

Related U.S. Application Data
(63) Continuation of application No. PCT/US2023/075587, filed on Sep. 29, 2023.
(60) Provisional application No. 63/413,186, filed on Oct. 4, 2022.
(60) Provisional application No. 63/413,190, filed on Oct. 4, 2022.

(51) Int. Cl. F02M 21/02; F02M 21/04

(52) U.S. Cl. CPC F02M 21/0269; F02M 21/0275; F02M 21/04

(57) ABSTRACT

Systems, apparatus, and methods described herein can overcome some of the disadvantages of existing internal combustion engines. In particular, systems, apparatus, and methods described herein can improve the mixing uniformity of fuel and air in internal combustion engines. In some aspects, an engine can include a fuel supply, a pressure regulator, an electric gas valve configured to control fuel flow, a fuel injector, the fuel injector including a mechanical fuel admission valve and a shroud, a cam configured to control the mechanical fuel admission valve, and a main combustion chamber including a piston and a top surface configured to contact the shroud of the fuel injector, wherein the shroud includes a rounded surface configured to direct a flow of fuel toward a geometric center of the piston. In some embodiments, the mechanical fuel admission valve can include an enlarged distal end configured to contact a surface of the shroud.

### RELATED APPLICATIONS

This application is a continuation of PCT Application No. PCT/US2023/075587, filed Sep. 29, 2023, and titled “Enhanced Fuel Mixing Systems for Direct Injected Natural Gas Engines, and Devices and Methods Thereof,” which claims priority to U.S. Provisional Application No. 63/413,190, filed Oct. 4, 2022, and titled “Enhanced Fuel Mixing Systems (EFMSS) for Piston-Scavenged Engines, and Devices and Methods Thereof,” and U.S. Provisional Application No. 63/413,186, filed Oct. 4, 2022, and titled “Systems, Devices, and Methods for Reducing Nitrogen Oxide and Methane Emissions in Piston Scavenged Engines,” the disclosures which are hereby incorporated by reference in their entireties.

### TECHNICAL FIELD

The present disclosure relates generally to systems, apparatus, and methods for enhancing the mixing of fuel and air in combustion chambers of internal combustion engines.

### BACKGROUND

Several industry emissions service companies have historically pursued development of new gas admissions systems to retrofit legacy two-stroke engines. These new gas admissions systems were generically referred to as high pressure fuel injection (HPFI) systems. HPFI retrofitted engines improved emissions significantly, reduced fuel consumption, and improved engine stability. However, HPFI engine upgrades are very costly. They require significant infrastructure upgrades within the compression stations to re-pipe the fuel to handle a high pressure (i.e., about 500 psi) fuel transfer. Such systems were often only rated for 150 psi. Such an upgrade can cost $50,000 or more per engine. Additionally, HPFI fuel valves are often electrically actuated. This necessitates electrical power supplied to each cylinder and to the engine controls panel for a central HPFI controller. In some cases, HPFI valve installation can requires slight head machining modifications. With all costs considered, a typical HPFI retrofit can cost $500,000-$700,000 per engine and can require an engine downtime of 20-30 days. Given these significant costs and downtime, it is desirable to have better systems, devices, and methods for enhancing fuel mixing.

### SUMMARY

Systems, apparatus, and methods described herein can overcome some of the disadvantages of existing internal combustion engines. In particular, systems, apparatus, and methods described herein can improve the mixing uniformity of fuel and air in internal combustion engines. In some aspects, an engine can include a fuel supply, a pressure regulator, an electric gas valve, a fuel injector, a cam and a main combustion chamber. The electric gas valve can control fuel flow (e.g., a governor valve). The fuel injector can include a mechanical fuel admission valve and a shroud. The cam can control the mechanical fuel admission valve (MGAV) and the shroud around a nozzle (e.g., internal MGAV cartridge ports angled to produce increased swirl). The main combustion chamber can include a piston and a top surface that contacts the shroud of the fuel injector. The shroud can include a rounded surface configured to direct a flow of fuel toward a geometric center of the piston. In some embodiments, the mechanical fuel admission valve can include an enlarged distal end configured to contact a surface of the shroud.

In some embodiments, the mechanical fuel admission valve can have an enlarged distal end that contacts a surface of the shroud. In some embodiments, the combustion chamber can include an opening integrated into a head of the combustion chamber. The opening can house a spark plug and/or a radical chemical generator. In some embodiments, the shroud can further include an angled surface adjacent to the rounded surface. The angled surface can be oriented, such that an upper end of the angled surface has a smaller diameter than a lower end of the angled surface.

Systems, devices, and methods described herein provide a 3.0 gram (or less) NOₓ reduction solution for engines (e.g., piston-scavenged engines or other engines that have a blower and/or turbo to boost air to the engine) that reduces nitrogen oxides (NOₓ) emissions below 3.0 gr/bhp-hr (grams per brake horsepower-hour) and reduces methane emissions (i.e., emissions of CH₄) by at least 20-30% relative to an unmodified engine, such as, for example, a GMV engine or other piston-scavenged engine. Systems, devices, and methods described herein for the RCTClean solution (i.e., 3.0-gram solution) do not require adding a turbocharger (Turbo) or high pressure fuel injection (HPFI) (i.e., fueling system that introduces fuel into an engine at pressures >400 psi). By eliminating the requirement for these two items, systems, devices, and methods described herein reduce the cost and the installation time and disruption by at least about 50% compared to other solutions that require a Turbo and/or HPFI.

Emissions reduction regulations required by the Environmental Protection Agency (EPA) or other governmental authorities require previously-installed 2-stroke lean-burn engines with greater than 1,000 hp (horsepower) to meet a NOₓ limit of 3.0 gr/bhp-hr. One such EPA regulation is “A Federal Implementation Plan addressing Regional Ozone Transport for the 2015 Ozone National Ambient Air Quality Standard,” commonly referred to as the Good Neighbor Plan (GNP). It is anticipated that that such regulations can be implemented as soon as 2023, with a compliance period of 3 years. Traditional industry emissions reduction solutions for GMV and other piston-scavenged engines are built around two major retrofit components: 1) adding a turbocharger to increase air-fuel ratio; and/or 2) adding HPFI to improve the fuel-air mixing. HPFI can be accompanied with an autobalance control system. Typical HPFI system costs can range from about $500,000-$750,000 per engine. Additional ancillary components include precombustion chambers (PCCs), new ignition-control systems, and/or other advanced control systems (e.g., autobalance systems, etc.). Some emissions reduction companies are just offering the addition of PCCs and the addition of a turbocharger/upgrade to achieve compliance with the GNP 3.0 gram limit in order to reduce the high additional cost of adding an HPFI system. This solution can achieve sub-3.0 gram NOₓ compliance, but will cause CH₄ levels to increase versus the unmodified engine.

Natural gas pipeline industry companies have provided industry comments to the EPA regarding the cost estimates for compliance with the GNP, which estimate the cost to upgrade an unmodified piston-scavenged engine such as GMV-10 engines to range from $2.2 million-3.8 million. These estimates are based on using traditional industry emissions reduction solutions (e.g., Turbo, HPFI, etc.). Given these significant costs, it is therefore desirable to have better solutions for reducing NOₓ and methane emissions.

### BRIEF DESCRIPTION OF THE DRAWINGS

The patent or application file contains at least one drawing executed in color. Copies of this patent or patent application publication with color drawing(s) will be provided by the office upon request and payment of the necessary fee.

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a block diagram of a fuel mixing system, according to an embodiment.

FIGS. 2A-2B are schematic illustrations of a fuel mixing system, according to an embodiment.

FIGS. 3A-3C are illustrations of a combustion chamber, and adjoining components, according to an embodiment.

FIGS. 4A-4D are schematic illustrations of a shroud, according to an embodiment.

FIGS. 5A-5B are photographs of an exterior of a fuel injector, according to an embodiment.

FIG. 6 is a flow diagram of a method of fuel combustion, according to an embodiment.

FIG. 7 is an illustration of interactions between pipelines and shrouded MGAV's, according to an embodiment.

FIG. 8 is a graph comparing air-fuel ratios at different crank angles, based on different injection pressures, intake valve opening times, and different fuel injection valve designs (orifice and poppet sizes, opening lift, etc.).

FIG. 9 compares valve opening profiles for various combustion strategies.

FIGS. 10A-10C are combustion profiles of a mechanical gas admission valve (MGAV) (alternatively referred to as mechanical fuel admission valve) scheme, according to an embodiment.

FIGS. 11A-11C are combustion profiles of a shrouded MGAV scheme, according to an embodiment.

FIGS. 12A-12C are combustion profiles of an HPFI scheme, according to an embodiment.

FIG. 13 is a graph comparing equivalence ratios at different crank angles, based on different injection pressures and intake valve opening times.

FIG. 14 depicts a graph showing the NOₓ and CH₄ emissions of an engine with one or more modifications, according to embodiments.

FIG. 15 depicts a graph showing the NOₓ and CH₄ emissions of an engine with one or more modifications, according to embodiments.

FIG. 16 is a schematic diagram of an example RCG, according to embodiments.

### DETAILED DESCRIPTION

Systems, apparatus, and methods are described herein for improving performance of internal combustion engines. Such systems, apparatus, and methods can improve performance by tuning the action of the cylinders of engines. Benefits of embodiments described herein include lower cost of retrofitting engines versus purchasing new engines.

Embodiments described herein include modifications to fuel valves used in piston-scavenged or lean-burn engines. Such engines can include 2-cycle engines, 4-cycle engines, such as Cooper-Bessemer (GMV) engines, GMVA, GMVC, or GMW, GMWA, Large Bore Natural gas Integral compressor engines, Clark TLA, HRA, HBA, RA, BA, Ingersoll-Rand, KBS, KBSR, or Worthington UTC engines can reduce emissions, improve engine stability, and/or improve fuel economy.

The original equipment manufacturer (OEM) MGAV's used on a GMV engine often operate at a pressure between about 30 psi and about 35 psi. When these MGAV's admit fuel into a main combustion chamber (MCC) during each cycle, they often produce a stratified, non-homogeneous fuel-air mixture. MGAV's do not require electrical power. MGAV's are mechanically driven via cams located on a main drive shaft. The MGAV timing profile is often set to open for about 94 crank angle degrees (CAD) to admit the required fuel with a supply pressure at about 30-35 psi. MGAV's when operated under such pressures and timing configurations, often result in pockets within the MCC that are leaner and richer than the average equivalence ratio desired in the engine (e.g., an equivalence ratio used for optimal performance). The equivalence ratio can be understood to be the ratio of the actual fuel/air ratio to a stoichiometric fuel/air ratio. Stoichiometric combustion occurs when all oxygen is consumed in the combustion reaction and there is no molecular oxygen (O₂) in the products.

Embodiments described herein can enhance electronic fuel management systems (EMFS) by: (1) increasing a supply pressure of fuel to about 90-100 psi (approximately three times a standard pressure operation); (2) reducing valve open timing from 90 crank angle degrees (CAD) to about 20-25 CAD; (3) increasing the instantaneous flowrate by increasing the minimum valve flow area, or the “curtain area”; (4) improving fuel nozzle directional flow by adding a shroud to direct the flow downward onto a piston center; and with (5) setting start-of-admission (SOA) to about 115-120 CAD before top dead center (BTDC) and ensuring there is no fuel leakage out of the exhaust ports before the exhaust ports close.

In some embodiments, a pressure regulator can be set to a pressure of between about 90 psi and 100 psi to increase the supply pressure of the fuel. In some embodiments, the pressure regulator can be changed or swapped out to allow fuel supply pressure to be set at a pressure of between about 90 psi and about 100 psi. In some embodiments, reducing the valve open timing can be accomplished via cams shaped to allow for a valve open timing of about 20-25 CAD. In some embodiments, a shroud can be attached to the MGAV fuel valve in order to improve the fuel nozzle flow. For example, the shroud can be welded onto a valve poppet annulus. In some embodiments, the SOA of the cam can be set to about 118 degrees BTDC, or another point, depending on the engine type. The Enhanced Fuel Mixing Systems (EFMS) described herein that include some or all of these modifications can deliver improved fuel-air mixing that is equal to or better than the mixing delivered by HPFI.

Systems and devices described herein increase fuel jet momentum by coupling together the sMGAV with a shortened injection duration (e.g., less than about 30 CAD) and higher fuel supply pressure and corresponding shortened injection duration (e.g., about 90 to about 150 psi), achieving the same level of mixing as HPFI. The momentum of a jet is equal to the mass flowrate X velocity. In the case of HPFI, a high momentum is achieved by using a high injection pressure (e.g., 500 psi), which produces sonic velocity (choked flow) at the valve exit at high density, generating a high mass flowrate and high exit jet momentum. Systems and devices described herein achieve high momentum at a lower injection pressure than the HPFI (e.g., about 90 psi to about 150 psi), but with a larger valve flow area relative to HPFI. The valve exit velocity is sonic, since the absolute pressure ratio (injection pressure/cylinder pressure) is greater than 2, but the gas has a lower density and a lower mass flowrate for the same valve flow area. For systems and devices described herein, the mass flowrate is increased compared to OEM MGAV, which operates at 30 psi and 90 CAD opening duration, thereby achieving a similar exit jet momentum to HPFI. The sMGAV shroud is designed such that the flow is choked at the valve exit. This is accomplished by assuring that no region within the valve has a smaller flow area than the exit area at the shroud. That way there are no regions within the valve where the flow is choked. If the flow chokes within the valve the regions downstream can have supersonic flow, which would result in high viscous losses. The opening size of the valves is inversely proportional to the speed and momentum of the jet. A higher speed of movement of the fuel makes the fuel more likely to be supersonic and have viscous losses. Pressure, duration, and cross-sectional area are all variables that can be modified to control fuel flow rate and momentum. Momentum and other parameters can be described in the equations below.

$$p = \dot{m} * v$$

Where p is momentum

$$( kg \frac{m}{s} ) ;$$

\dot{m} is mass flow rate

$$\frac{kg}{s} ;$$

and
v is velocity

$$\frac{m}{s} .$$

$$\dot{m} = ρ * A * v$$

Where ρ is density

$$\frac{kg}{{m}^{3}} ;$$

A is cross-sectional area (m³);
v is velocity

$$\frac{m}{s} .$$

$$\dot{m} = \frac{m}{Δ t}$$

Where m is mass flow rate

$$\frac{kg}{s} ;$$

m is mass of fuel (kg); and
Δt is duration of valve opening(s).

Systems, devices, and methods described herein for reducing NOₓ and methane emissions include combustion enhancement, air enhancement, fuel mixing enhancement, and advanced engine control improvement contributions in several areas. These enhancement and improvements together can deliver the required 3.0 gram/bhp-hr NOₓ reduction with 20-30% CH₄ reduction. With additional engine tuning it is anticipated that CH₄ emissions reduction will approach 50%. In addition, engine combustion stability can be greatly improved.

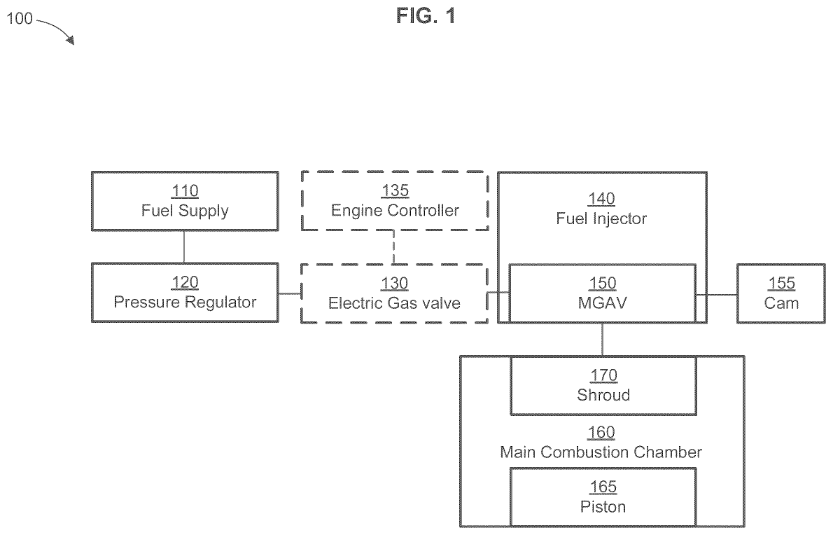

Systems, devices, and methods can include one or more of the following components for providing reduced NOₓ and methane emissions:
1. Improved ignition and combustion using, for example, one or more pre-combustion chambers (PCCs) and/or radical chemicals generators (RCGs). In some embodiments, such RCGs can be optimized for performance with the flow pattern of a particular engine. Suitable examples of RCGs are described in U.S. patent application Ser. No. 17/680,074, filed Feb. 24, 2022, titled “Systems, Apparatus, and Methods for Inducing Enhanced Radical Ignition in Internal Combustion Engines Using a Radical Chemicals Generator,” published as U.S. Patent Application Publication No. 2022/0178300, the disclosure of which is incorporated herein by reference in its entirety.
2. Optimized RCG location in the head of an engine. For example, one or more RCGs can be placed in specific locations (e.g., optimal locations) in the head of an engine to enhance combustion. Locations can be, for example, at a primary spark-plug port; at a secondary spark-plug port; at a primary spark-plug port with the head rotated 180 degrees; at a secondary spark-plug port with head rotated 180 degrees; and/or other head location. RCG location has historically been limited by the existing ports, but systems described herein allow for placement in multiple ports.
3. Improved fuel mixing system using, for example, a medium-pressure fuel mixing system or enhanced fuel mixing system (EFMS) to meet or exceed fuel mixing achieved using HPFI. In some embodiments, the medium pressure fuel mixing system can be a mechanically driven fuel mixing system, as described with respect to FIGS. 1-6.
4. Increasing boost by increasing engine speed, e.g., from about 300 RPM up to about 330 RPM, or by installing a blower or turbocharger, or by using existing turbocharger or other air enhancement system.
5. Add a back pressure valve (BPV) to exhaust line to trap more air in the combustion cylinder to improve emissions.
6. Add engine Peak Pressure Ratio (PPR) balancing or other balancing and control features for emissions-reduction enhancement. In some embodiments, a balancing scheme can include balancing on peak pressure (i.e., each cylinder would have the same average peak pressure). Other balancing schemes can include peak pressure ratio, coefficient of variation of peak pressure, location of 50% mass fraction burned, and/or exhaust port temperature.

### Enhanced Fuel Mixing

FIG. 1 is a block diagram of a fuel mixing system 100, according to an embodiment. As shown, the fuel mixing system 100 includes a fuel supply 110 and a pressure regulator 120 fluidically coupled to the fuel supply 110. In some embodiments, the fuel mixing system 100 further includes a fuel injector 140, a MGAV 150 actuated by a cam 155, and a main combustion chamber (MCC) 160 including a piston 165 and a shroud 170. Alternatively, or additionally, in some embodiments, the fuel mixing system 100 includes an electric gas valve 130 controlled by an engine controller 135.

In some embodiments, the fuel mixing system can include a 2-stroke engine, a 2-stroke lean-burn engine, a natural gas compressor engine, a direct-injected cam-driven engine, a 4-stroke engine, a 4-stroke lean-burn engine, a large bore integral engine, a 4-stroke large bore natural gas engine, an Ingersoll-Rand KVS-412 engine, or any combination thereof.

The fuel supply 110 contains a fuel for combustion. In some embodiments, the fuel supply 110 can be filled via a fill line (not shown). In some embodiments, the fuel can include a gaseous fuel, natural gas, hydrogen, biogas, renewable gas fuel, or any combination thereof. In some embodiments, the fuel supply 110 can include a pressurized fuel line and/or a fuel header.

In some embodiments, the fuel supply 110 can have a volume of at least about 1 L, at least about 2 L, at least about 3 L, at least about 4 L, at least about 5 L, at least about 6 L, at least about 7 L, at least about 8 L, at least about 9 L, at least about 10 L, least about 20 L, at least about 30 L, at least about 40 L, at least about 50 L, at least about 60 L, at least about 70 L, at least about 80 L, at least about 90 L, at least about 100 L, at least about 200 L, at least about 300 L, at least about 400 L, at least about 500 L, at least about 600 L, at least about 700 L, at least about 800 L, or at least about 900 L. In some embodiments, the fuel supply 110 can have a volume of no more than about 1,000 L, no more than about 900 L, no more than about 800 L, no more than about 700 L, no more than about 600 L, no more than about 500 L, no more than about 400 L, no more than about 300 L, no more than about 200 L, no more than about 100 L, no more than about 90 L, no more than about 80 L, no more than about 70 L, no more than about 60 L, no more than about 50 L, no more than about 40 L, no more than about 30 L, no more than about 20 L, no more than about 10 L, no more than about 9 L, no more than about 8 L, no more than about 7 L, no more than about 6 L, no more than about 5 L, no more than about 4 L, no more than about 3 L, or no more than about 2 L. Combinations of the above-referenced volumes are also possible (e.g., at least about 1 L and no more than about 1,000 L or at least about 50 L and no more than about 500 L), inclusive of all values and ranges therebetween. In some embodiments, the fuel supply 110 can have a volume of about 1 L, about 2 L, about 3 L, about 4 L, about 5 L, about 6 L, about 7 L, about 8 L, about 9 L, about 10 L, least about 20 L, about 30 L, about 40 L, about 50 L, about 60 L, about 70 L, about 80 L, about 90 L, about 100 L, about 200 L, about 300 L, about 400 L, about 500 L, about 600 L, about 700 L, about 800 L, about 900 L, or about 1,000 L.

The pressure regulator 120 is configured to provide pressure and/or volume regulation of the fuel. In some embodiments, the pressure regulator 120 can bleed off a portion of the fuel. In some embodiments, the pressure regulator 120 can recycle a portion of the fuel back to the fuel supply 110. In some embodiments, the pressure regulator 120 can be housed in a metered building separate from the combustion chamber 160.

In some embodiments, the pressure regulator 120 can regulate (i.e., increase or decrease) the pressure of the fuel being delivered via a fuel line to at least about 70 psi, at least about 75 psi, at least about 80 psi, at least about 85 psi, at least about 90 psi, at least about 95 psi, at least about 100 psi, at least about 105 psi, at least about 110 psi, at least about 115 psi, at least about 120 psi, at least about 125 psi, at least about 130 psi, at least about 135 psi, at least about 140 psi, or at least about 145 psi. In some embodiments, the pressure regulator 120 can regulate the pressure of the fuel being delivered to no more than about 150 psi, no more than about 145 psi, no more than about 140 psi, no more than about 135 psi, no more than about 130 psi, no more than about 125 psi, no more than about 120 psi, no more than about 115 psi, no more than about 110 psi, no more than about 105 psi, no more than about 100 psi, no more than about 95 psi, no more than about 90 psi, no more than about 85 psi, no more than about 80 psi, or no more than about 75 psi. Combinations of the above-referenced pressures are also possible (e.g., at least about 70 psi and no more than about 150 psi or at least about 90 psi and no more than about 100 psi), inclusive of all values and ranges therebetween. In some embodiments, the pressure regulator 120 can regulate the pressure of the fuel being delivered to about 70 psi, about 75 psi, about 80 psi, about 85 psi, about 90 psi, about 95 psi, about 100 psi, about 105 psi, about 110 psi, about 115 psi, about 120 psi, about 125 psi, about 130 psi, about 135 psi, about 140 psi, about 145 psi, or about 150 psi.

The electric gas valve 130 is optional and can act as a primary fuel control mechanism. In some embodiments, the electric gas valve 130 can act as a governor. The governor can analyze the selected speed and either slightly open or slightly close the valve to bring the fuel mixing system 100 to the desired RPM. In some embodiments, the electric gas valve 130 can be fluidically coupled to each of the cylinders. The governor splits off to a fuel header. In some embodiments, an electric gas valve 130 can be used in lieu of a MGAV 150. Alternatively, the electric gas valve 130 can be used together with a MGAV 150. For example, the electric gas valve 130 can control the duration of the fuel injection and the timing of SOA. The SOA can be timed to be within the open duration of the MGAV 150. In some embodiments, the electric gas valve 130 can increase the pressure of the fuel being delivered.

In some embodiments, the electric gas valve 130 can be open for at least about 10 CAD, at least about 15 CAD, at least about 20 CAD, at least about 25 CAD, at least about 30 CAD, at least about 35 CAD, at least about 40 CAD, at least about 45 CAD, or at least about 50 CAD, at least about 55 CAD. In some embodiments, the electric gas valve 130 can be open for no more than about 60 CAD, no more than about 55 CAD, no more than about 50 CAD, no more than about 45 CAD, no more than about 40 CAD, no more than about 35 CAD, no more than about 30 CAD, no more than about 25 CAD, or no more than about 20 CAD.

Combinations of the above-referenced CAD openings are also possible (e.g., at least about 10 CAD and no more than about 60 CAD or at least about 20 CAD and no more than about 40 CAD), inclusive of all values and ranges therebetween. In some embodiments, the electric gas valve 130 can be open for about 10 CAD, about 15 CAD, about 20 CAD, about 25 CAD, about 30 CAD, about 35 CAD, about 40 CAD, about 45 CAD, about 50 CAD, about 55 CAD, or about 60 CAD.

In some embodiments, the electric gas valve 130 can increase the pressure of the fuel to at least about 50 psi, at least about 100 psi, at least about 150 psi, at least about 200 psi, at least about 250 psi, at least about 300 psi, at least about 350 psi, at least about 400 psi, at least about 450 psi, at least about 500 psi, at least about 550 psi, at least about 600 psi, at least about 650 psi, at least about 700 psi, or at least about 750 psi. In some embodiments, the electric gas valve 130 can increase the pressure of the fuel to no more than about 800 psi, no more than about 750 psi, no more than about 700 psi, no more than about 650 psi, no more than about 600 psi, no more than about 550 psi, no more than about 500 psi, no more than about 450 psi, no more than about 400 psi, no more than about 350 psi, no more than about 300 psi, no more than about 250 psi, no more than about 200 psi, no more than about 150 psi, or no more than about 100 psi. Combinations of the above-referenced pressures are also possible (e.g., at least about 50 psi and no more than about 800 psi or at least about 400 psi and no more than about 600 psi), inclusive of all values and ranges therebetween. In some embodiments, the electric gas valve 130 can increase the pressure of the fuel to about 50 psi, about 100 psi, about 150 psi, about 200 psi, about 250 psi, about 300 psi, about 350 psi, about 400 psi, about 450 psi, about 500 psi, about 550 psi, about 600 psi, about 650 psi, about 700 psi, about 750 psi, or about 800 psi.

The engine controller 135 is configured to control the timing of the ignition, the valve timing, and/or any other properties of the engine. In embodiments including an electric gas valve 130, the engine controller 135 can be configured to control operation of the electric gas valve 130, e.g., to open and/or close the electric gas valve 130. In some embodiments, the engine controller 135 can be manually operated. In some embodiments, the engine controller 135 can be automatic. For example, the engine controller 135 can include a processor coupled to a memory. The processor can be configured to run and/or execute functions associated with the engine. For example, the processor can be configured to control the timing of valve opening and/or closing, the timing of ignition, etc. In some embodiments, the engine controller 135 can include a user interface, at which a user can make changes to the fuel pressure. In some embodiments, the engine controller 135 can be configured to run processes associated with balancing or tuning of an engine.

The fuel injector 140 regulates the movement of fuel into the combustion chamber 160, thereby controlling fuel delivery into the combustion chamber 160. The MGAV 150 lifts to allow fuel into the MCC 160. In some embodiments, the MGAV can include an enlarged distal end that blocks an opening at a distal end of the fuel injector 140. The blocking of the opening at the distal end of the fuel injector 140 constitutes a closing of the MGAV 150. In the case where the electric gas valve 130 is included in the fuel mixing system 100, the electric gas valve 130 can become the primary control mechanism of fuel injection into the MCC 160. The MGAV 150 would has a longer open duration than the electric gas valve 130. By opening the MGAV 150 sooner and closing the MGAV 150 later than the electric gas valve 130, the original profile of the cam 155 is no longer the main controlling mechanism of fuel flow into the MCC 160. The fuel is flowing through the MGAV 150 as it would without the electric gas valve 130, but the flow of fuel is cut off sooner via the electric gas valve 130.

In some embodiments, the MGAV 150 can be open for at least about 15 CAD, at least about 16 CAD, at least about 17 CAD, at least about 18 CAD, at least about 19 CAD, at least about 20 CAD, at least about 21 CAD, at least about 22 CAD, at least about 23 CAD, at least about 24 CAD, at least about 25 CAD, at least about 26 CAD, at least about 27 CAD, at least about 28 CAD, at least about 29 CAD, at least about 30 CAD, at least about 31 CAD, at least about 32 CAD, at least about 33 CAD, or at least about 34 CAD. In some embodiments, the MGAV 150 can be open for no more than about 35 CAD, no more than about 34 CAD, no more than about 33 CAD, no more than about 32 CAD, no more than about 31 CAD, no more than about 30 CAD, no more than about 29 CAD, no more than about 28 CAD, no more than about 27 CAD, no more than about 26 CAD, no more than about 25 CAD, no more than about 24 CAD, no more than about 23 CAD, no more than about 22 CAD, no more than about 21 CAD, no more than about 20 CAD, no more than about 19 CAD, no more than about 18 CAD, no more than about 17 CAD, or no more than about 16 CAD. Combinations of the above-referenced CAD opening times are also possible (e.g., at least about 15 CAD and no more than about 35 CAD or at least about 20 CAD and no more than about 30 CAD), inclusive of all values and ranges therebetween. In some embodiments, the MGAV 150 can be open for about 15 CAD, about 16 CAD, about 17 CAD, about 18 CAD, about 19 CAD, about 20 CAD, about 21 CAD, about 22 CAD, about 23 CAD, about 24 CAD, about 25 CAD, about 26 CAD, about 27 CAD, about 28 CAD, about 29 CAD, about 30 CAD, about 31 CAD, about 32 CAD, about 33 CAD, about 34 CAD, or about 35 CAD.

In some embodiments, the initial opening of the MGAV 150 can trigger SOA. In some embodiments, the opening of the MGAV 150 can begin at least about 100 CAD BTDC, at least about 101 CAD BTDC, at least about 102 CAD BTDC, at least about 103 CAD BTDC, at least about 104 CAD BTDC, at least about 105 CAD BTDC, at least about 106 CAD BTDC, at least about 107 CAD BTDC, at least about 108 CAD BTDC, at least about 109 CAD BTDC, at least about 110 CAD BTDC, at least about 111 CAD BTDC, at least about 112 CAD BTDC, at least about 113 CAD BTDC, at least about 114 CAD BTDC, at least about 115 CAD BTDC, at least about 116 CAD BTDC, at least about 117 CAD BTDC, at least about 118 CAD BTDC, at least about 119 CAD BTDC, at least about 120 CAD BTDC, at least about 121 CAD BTDC, at least about 122 CAD BTDC, at least about 123 CAD BTDC, at least about 124 CAD BTDC, at least about 125 CAD BTDC, at least about 126 CAD BTDC, at least about 127 CAD BTDC, at least about 128 CAD BTDC, or at least about 129 CAD BTDC. In some embodiments, the opening of the MGAV 150 can begin at no more than about 130 CAD BTDC, no more than about 129 CAD BTDC, no more than about 128 CAD BTDC, no more than about 127 CAD BTDC, no more than about 126 CAD BTDC, no more than about 125 CAD BTDC, no more than about 124 CAD BTDC, no more than about 123 CAD BTDC, no more than about 122 CAD BTDC, no more than about 121 CAD BTDC, no more than about 120 CAD BTDC, no more than about 119 CAD BTDC, no more than about 118 CAD BTDC, no more than about 117 CAD BTDC, no more than about 116 CAD BTDC, no more than about 115 CAD BTDC, no more than about 114 CAD BTDC, no more than about 113 CAD BTDC, no more than about 112 CAD BTDC, no more than about 111 CAD BTDC, no more than about 110 CAD BTDC, no more than about 109 CAD BTDC, no more than about 108 CAD BTDC, no more than about 107 CAD BTDC, no more than about 106 CAD BTDC, no more than about 105 CAD BTDC, no more than about 104 CAD BTDC, no more than about 103 CAD BTDC, no more than about 102 CAD BTDC, or no more than about 101 CAD BTDC. Combinations of the above-referenced crank angles, at which the MGAV 150 initially opens are also possible (e.g., at least about 100 CAD BTDC and no more than about 130 CAD BTDC or at least about 110 CAD BTDC and no more than about 125 CAD BTDC), inclusive of all values and ranges therebetween. In some embodiments, the opening of the MGAV 150 can begin about 100 CAD BTDC, about 101 CAD BTDC, about 102 CAD BTDC, about 103 CAD BTDC, about 104 CAD BTDC, about 105 CAD BTDC, about 106 CAD BTDC, about 107 CAD BTDC, about 108 CAD BTDC, about 109 CAD BTDC, about 110 CAD BTDC, about 111 CAD BTDC, about 112 CAD BTDC, about 113 CAD BTDC, about 114 CAD BTDC, about 115 CAD BTDC, about 116 CAD BTDC, about 117 CAD BTDC, about 118 CAD BTDC, about 119 CAD BTDC, about 120 CAD BTDC, about 121 CAD BTDC, about 122 CAD BTDC, about 123 CAD BTDC, about 124 CAD BTDC, about 125 CAD BTDC, about 126 CAD BTDC, about 127 CAD BTDC, about 128 CAD BTDC, about 129 CAD BTDC, or about 130 CAD BTDC.

In some embodiments, the closing of the MGAV 150 can end fuel injection. In some embodiments, the opening of the MGAV 150 can end (i.e., the MGAV 150 can close) at an engine crank angle of at least about 70 CAD BTDC, at least about 71 CAD BTDC, at least about 72 CAD BTDC, at least about 73 CAD BTDC, at least about 74 CAD BTDC, at least about 75 CAD BTDC, at least about 76 CAD BTDC, at least about 77 CAD BTDC, at least about 78 CAD BTDC, at least about 79 CAD BTDC, at least about 80 CAD BTDC, at least about 81 CAD BTDC, at least about 82 CAD BTDC, at least about 83 CAD BTDC, at least about 84 CAD

BTDC, at least about 85 CAD BTDC, at least about 86 CAD BTDC, at least about 87 CAD BTDC, at least about 88 CAD BTDC, at least about 89 CAD BTDC, at least about 90 CAD BTDC, at least about 91 CAD BTDC, at least about 92 CAD BTDC, at least about 93 CAD BTDC, at least about 94 CAD BTDC, at least about 95 CAD BTDC, at least about 96 CAD BTDC, at least about 97 CAD BTDC, at least about 98 CAD BTDC, or at least about 99 CAD BTDC. In some embodiments, the opening of the MGAV 150 can end at an engine crank angle of no more than about 100 CAD BTDC, no more than about 99 CAD BTDC, no more than about 98 CAD BTDC, no more than about 97 CAD BTDC, no more than about 96 CAD BTDC, no more than about 95 CAD BTDC, no more than about 94 CAD BTDC, no more than about 93 CAD BTDC, no more than about 92 CAD BTDC, no more than about 91 CAD BTDC, no more than about 90 CAD BTDC, no more than about 89 CAD BTDC, no more than about 88 CAD BTDC, no more than about 87 CAD BTDC, no more than about 86 CAD BTDC, no more than about 85 CAD BTDC, no more than about 84 CAD BTDC, no more than about 83 CAD BTDC, no more than about 82 CAD BTDC, no more than about 81 CAD BTDC, no more than about 80 CAD BTDC, no more than about 79 CAD BTDC, no more than about 78 CAD BTDC, no more than about 77 CAD BTDC, no more than about 76 CAD BTDC, no more than about 75 CAD BTDC, no more than about 74 CAD BTDC, no more than about 73 CAD BTDC, no more than about 72 CAD BTDC, or no more than about 71 CAD BTDC. Combinations of the above-referenced crank angles are also possible (e.g., at least about 70 CAD and no more than about 100 CAD or at least about 75 CAD and no more than about 95 CAD), inclusive of all values and ranges therebetween. In some embodiments, the opening of the MGAV 150 can end at about 70 CAD BTDC, about 71 CAD BTDC, about 72 CAD BTDC, about 73 CAD BTDC, about 74 CAD BTDC, about 75 CAD BTDC, about 76 CAD BTDC, about 77 CAD BTDC, about 78 CAD BTDC, about 79 CAD BTDC, about 80 CAD BTDC, about 81 CAD BTDC, about 82 CAD BTDC, about 83 CAD BTDC, about 84 CAD BTDC, about 85 CAD BTDC, about 86 CAD BTDC, about 87 CAD BTDC, about 88 CAD BTDC, about 89 CAD BTDC, about 90 CAD BTDC, about 91 CAD BTDC, about 92 CAD BTDC, about 93 CAD BTDC, about 94 CAD BTDC, about 95 CAD BTDC, about 96 CAD BTDC, about 97 CAD BTDC, about 98 CAD BTDC, about 99 CAD BTDC, or about 100 CAD BTDC.

The cam 155 is coupled to the MGAV 150 to influence the MGAV 150 to open. In some embodiments, the MGAV 150 can be held shut via a spring (not shown) and the cam 155 can push the MGAV 150 against the spring to open the MGAV 150. In some embodiments, the cam 155 can be attached to a crankshaft (not shown). In some embodiments, the cam 155 can have a teardrop shape, e.g., such that rotation of the cam 155 can selectively push on the MGAV 150 to open the valve. In some embodiments, the shape of the cam 155 can control the opening time of the MGAV 150.

The MCC 160 includes a piston 165 that moves from bottom dead center (BDC) to top dead center (TDC) and back. Combustion occurs in the main combustion chamber 160. In some embodiments, the MCC 160 can include a spark plug (not shown) and/or another ignition assist device to facilitate ignition of the fuel. In some embodiments, a radical chemicals generator (RCG, not shown) can be integrated into the structure of the engine. RCG's are described in greater detail in U.S. Pat. No. 11,466,608 (“the '608 patent”), filed Feb. 24, 2022, and titled “Systems, Apparatus, and Methods for Inducing Enhanced Radical Ignition in Internal Combustion Engines Using a Radical Chemicals Generator,” the disclosure of which is hereby incorporated by reference in its entirety.

The shroud 170 guides and/or influences the flow of fuel in the MCC 160. In some embodiments, the shroud 170 can be structurally integrated into the MCC 160. In some embodiments, the shroud 170 can be structurally integrated into the fuel injector 140. In some embodiments, the shroud 170 can be shaped to direct fuel toward a radial center of the MCC 160. In some embodiments, the shroud 170 can include curved surfaces. In some embodiments, the shroud 170 can include flat surfaces. In some embodiments, the shroud 170 can include angled surfaces.

While FIG. 1 depicts a fuel mixing system that is coupled to a single MCC 160, it can be appreciated that the fuel mixing systems described herein can be coupled to multiple MCCs 160, e.g., such as the MCCs of a plurality of cylinders of an engine.

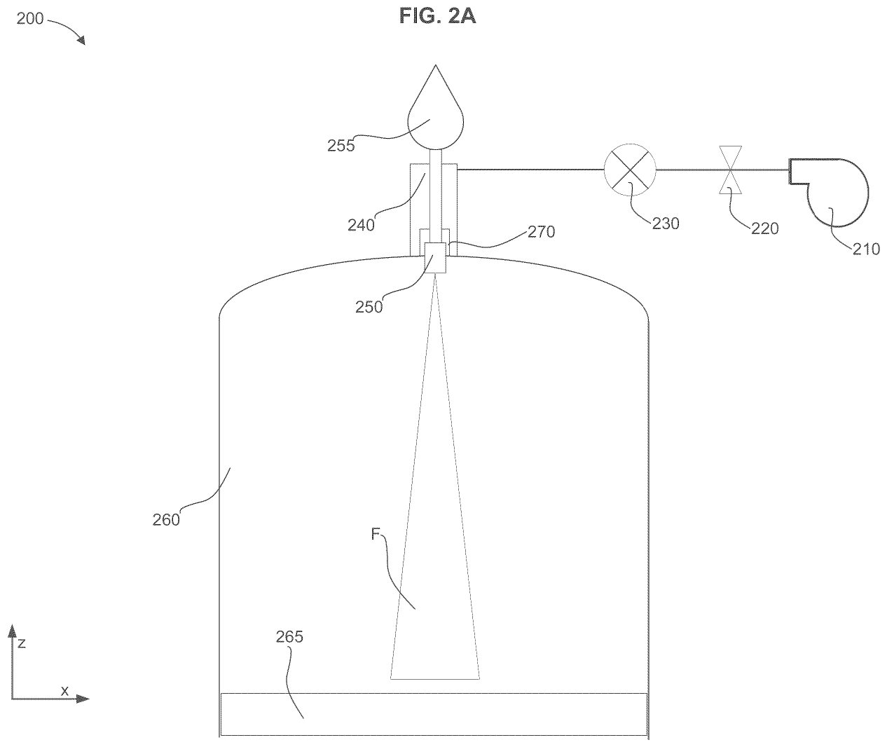

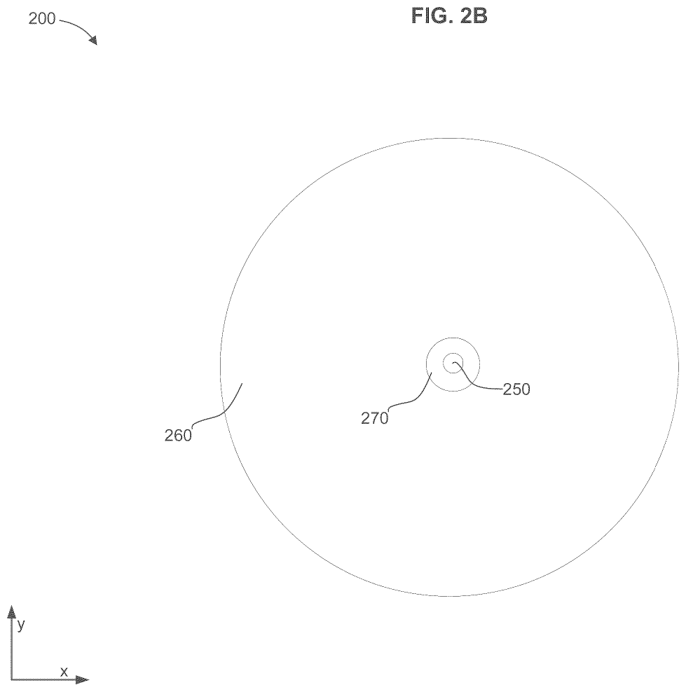

FIGS. 2A-2B are illustrations of a fuel mixing system 200, according to an embodiment. As shown, the fuel mixing system 200 includes a fuel supply 210, a pressure regulator 220, an electric gas valve 230, a fuel injector 240, a MGAV 250, a cam 255, a MCC 260, a piston 265, and a shroud 270. In some embodiments, the fuel supply 210, the pressure regulator 220, the electric gas valve 230, the fuel injector 240, the MGAV 250, the cam 255, the MCC 260, the piston 265, and the shroud 270 can be the same or substantially similar to the fuel supply 110, the pressure regulator 120, the electric gas valve 130, the fuel injector 140, the MGAV 150, the cam 155, the MCC 160, the piston 165, and the shroud 170, as described above with reference to FIG. 1. Thus, certain aspects of the fuel supply 210, the pressure regulator 220, the electric gas valve 230, the fuel injector 240, the MGAV 250, the cam 255, the MCC 260, the piston 265, and the shroud 270 are not described in greater detail herein. FIG. 2A shows a side view of the injection of a fuel F into the MCC 260. FIG. 2B shows a bottom view of the MGAV 250 and the shroud 270 from within the MCC 260. Axes are shown for clarity. As shown, FIG. 2A is depicted along an x-z plane while FIG. 2B is depicted along an x-y plane.

The cam 255 can be shaped to minimize or reduce the opening time of the MGAV 250. In some embodiments, the cam 255 can be shaped to keep the MGAV 250 open for about 20 CAD, about 21 CAD, about 22 CAD, about 23 CAD, about 24 CAD, about 25 CAD, about 26 CAD, about 27 CAD, about 28 CAD, about 29 CAD, about 30 CAD, inclusive of all values and ranges therebetween.

As shown, the MCC 260 has a horizontal center along the x-axis. The stream of fuel F is formed by the shape of the shroud 270. In some embodiments, the stream of fuel F can be conical in shape. In some embodiments, the portion of the stream of fuel F that contacts the piston 255 can cover a breadth of about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, or about 95% of the diameter of the MCC 260. In some embodiments, the MGAV 250, the MCC 260, and the shroud 270 can all be centered around a common horizontal center. In other words, the MGAV 250, the MCC 260, and the shroud 270 can be concentric.

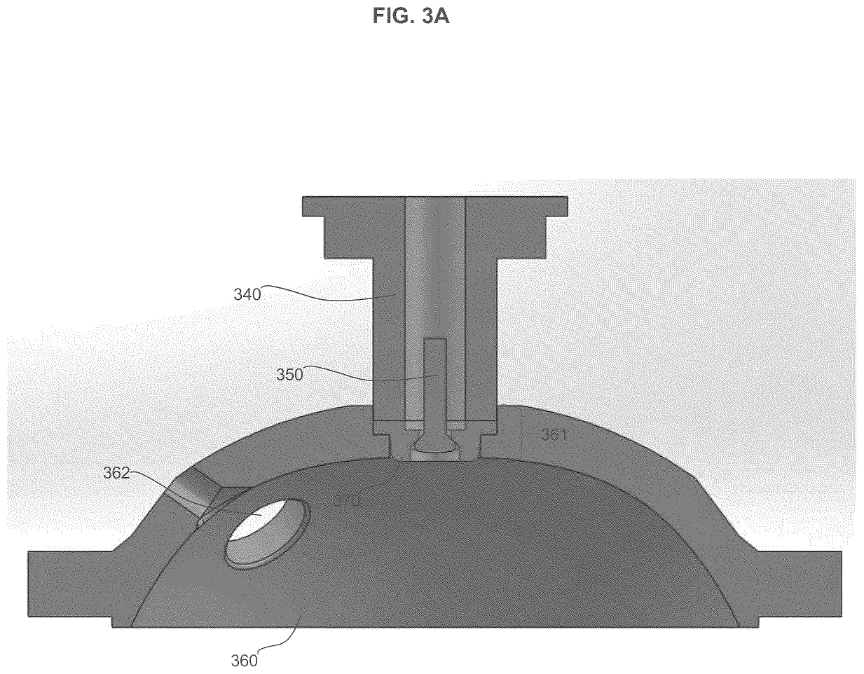

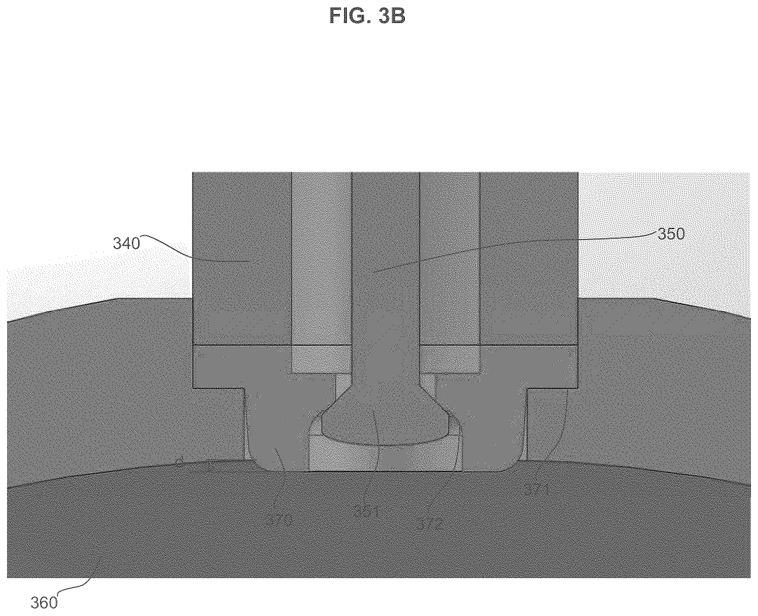

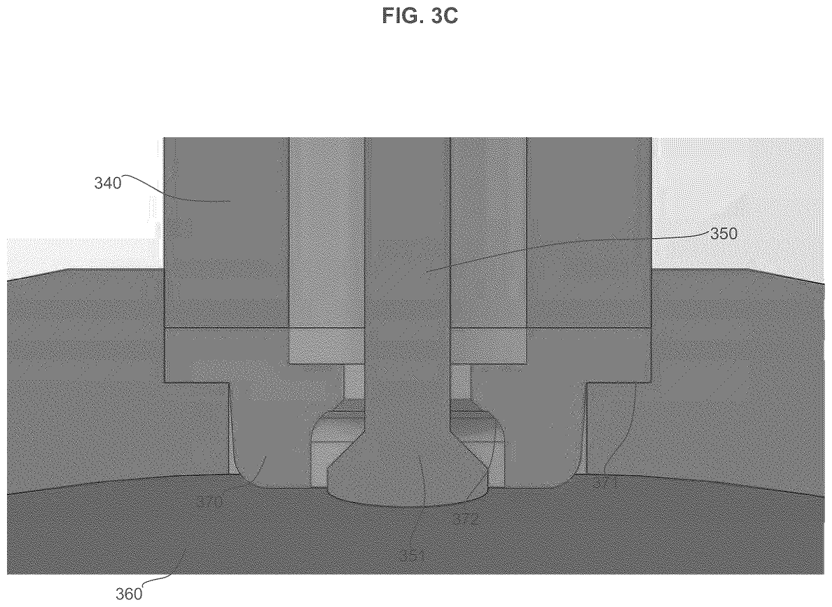

FIGS. 3A-3C show an MCC 360 with adjacent instrumentation attached thereto. As shown, the MCC 360 includes a primary opening 361 and a secondary opening 362. The MCC 360 is attached to a fuel injector 340, which includes an MGAV 350 (i.e., a poppet) and a shroud 370. The shroud 370 includes a lip 371 and a mating surface 372. In some embodiments, the fuel injector 340, the MGAV 350, the MCC 360, and the shroud 370 can be the same or substantially similar to the fuel injector 140, the MGAV 150, the MCC 160, and the shroud 170, as described above with reference to FIG. 1. Thus, certain aspects of the fuel injector 340, the MGAV 350, the MCC 360, and the shroud 370 are not described in greater detail herein. FIG. 3A shows a cross sectional view of the interaction between the MCC 360 and the fuel injector 340. FIG. 3B shows a detailed view of the shroud 370 with the MGAV 350 in a closed position. FIG. 3C shows a detailed view of the shroud 370 with the MGAV 350 in an open position.

As shown, the MGAV 350 fits against the mating surface 372 of the shroud 370. As shown, the MGAV 350 has an enlarged distal end 351 that blocks the flow of fuel through the shroud 370 when the enlarged distal end 351 of the MGAV 350 contacts the mating surface 372 of the shroud 370.

In some embodiments, the MGAV 350 can have a lift of at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, the MGAV 350 can have a lift of no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, or no more than about 200 μm. Combinations of the above-referenced lift distances are also possible (e.g., at least about 100 μm and no more than about 10 cm or at least about 1 mm and no more than about 1 cm), inclusive of all values and ranges therebetween. In some embodiments, the MGAV 350 can have a lift of about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

As shown, the shroud 370 fits into the primary opening 361 of the MCC 360. As shown, the lip 371 of the shroud 370 fits against a flat outer surface of the MCC 360. In some embodiments, the primary opening 361 can be positioned at the pole of an upper globe surface of the MCC 360. In some embodiments, the primary opening 361 can be positioned at a latitude of about 90 degrees (i.e., at or near the pole of the MCC 360). In some embodiments, the primary opening 361 can be located at a latitude of at least about 80 degrees, at least about 81 degrees, at least about 82 degrees, at least about 83 degrees, at least about 84 degrees, at least about 85 degrees, at least about 86 degrees, at least about 87 degrees, at least about 88 degrees, or at least about 89 degrees. In some embodiments, the primary opening 360 can be located at a latitude of no more than about 90 degrees, no more than about 89 degrees, no more than about 88 degrees, no more than about 87 degrees, no more than about 86 degrees, no more than about 85 degrees, no more than about 84 degrees, no more than about 83 degrees, no more than about 82 degrees, or no more than about 81 degrees. Combinations of the above-referenced latitudes are also possible (e.g., at least about 80 degrees and no more than about 90 degrees or at least about 82 degrees and no more than about 89 degrees), inclusive of all values and ranges therebetween. In some embodiments, the primary opening 361 can be located at a latitude of about 80 degrees, about 81 degrees, about 82 degrees, about 83 degrees, about 84 degrees, about 85 degrees, about 86 degrees, about 87 degrees, about 88 degrees, about 89 degrees, or about 90 degrees.

In some embodiments, the primary opening 361 can be concentric with the center of the MCC 360. In some embodiments, the primary opening 361 can have a diameter of at least about 2 mm, at least about 3 mm, at least about 4 mm, at least about 5 mm, at least about 6 mm, at least about 7 mm, at least about 8 mm, at least about 9 mm, at least about 1 cm, at least about 1.5 cm, at least about 2 cm, at least about 2.5 cm, at least about 3 cm, at least about 3.5 cm, at least about 4 cm, or at least about 4.5 cm. In some embodiments, the primary opening 361 can have a diameter of no more than about 5 cm, no more than about 4.5 cm, no more than about 4 cm, no more than about 3.5 cm, no more than about 3 cm, no more than about 2.5 cm, no more than about 2 cm, no more than about 1.5 cm, no more than about 1 cm, no more than about 9 mm, no more than about 8 mm, no more than about 7 mm, no more than about 6 mm, no more than about 5 mm, no more than about 4 mm, or no more than about 3 mm. Combinations of the above-referenced diameters are also possible (e.g., at least about 2 mm and no more than about 5 cm or at least about 5 mm and no more than about 1 cm), inclusive of all values and ranges therebetween. In some embodiments, the primary opening 361 can have a diameter of about 2 mm, about 3 mm, about 4 mm, about 5 mm, about 6 mm, about 7 mm, about 8 mm, about 9 mm, about 1 cm, about 1.5 cm, about 2 cm, about 2.5 cm, about 3 cm, about 3.5 cm, about 4 cm, about 4.5 cm, or about 5 cm.

In some embodiments, the shroud 370 can be placed into the primary opening 361, and the fuel injector 340 can be bolted to the shroud 370 and/or an outer surface of the MCC 360. Such a configuration can prevent leaks with a need to replace piping. In general, a larger shroud leads to a larger curtain area. As shown, the surfaces of the shroud 370 and the MGAV 350 are curved. This leads to a smoother, more gradual curtain area opening and closing, as opposed to surfaces with 90 degree surfaces.

As shown, the shroud 370 protrudes into the MCC 360 beyond the interior surface of the MCC 360 by a distance d. In some embodiments, the shroud 370 can be completely flush with the interior surface of the MCC 360. In some embodiments, the protrusion distance d can be at least about at least about 1 mm, at least about 2 mm, at least about 3 mm, at least about 4 mm, at least about 5 mm, at least about 6 mm, at least about 7 mm, at least about 8 mm, or at least about 9 mm. In some embodiments, the distance d can be no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, or no more than about 1 mm. Combinations of the above-referenced protrusion distances d are also possible (e.g., at least about 1 mm and no more than about 1 cm or at least about 3 mm and no more than about 5 mm), inclusive of all values and ranges therebetween. In some embodiments, the protrusion distance d can be, about 1 mm, about 2 mm, about 3 mm, about 4 mm, about 5 mm, about 6 mm, about 7 mm, about 8 mm, about 9 mm, or about 1 cm. In some embodiments, the shroud 370 can be flush or substantially flush with the interior surface of the MCC 360 (i.e., d can be zero). In other words, the protrusion distance can be 0 or about 0.

In some embodiments, the shroud 370 can be recessed from the interior surface of the MCC 360 by a distance d. In other words, the distance d can be negative. In some embodiments, the recession distance d can be at least about 1 mm, at least about 2 mm, at least about 3 mm, or at least about 4 mm. In some embodiments, the distance d can be no more than about 5 mm, no more than about 4 mm, no more than about 3 mm, no more than about 2 mm, or no more than about 1 mm. Combinations of the above-referenced protrusion distances d are also possible (e.g., at least about 1 mm and no more than about 5 mm or at least about 2 mm and no more than about 4 mm), inclusive of all values and ranges therebetween. In some embodiments, the recession distance d can be about 1 mm, about 2 mm, about 3 mm, about 4 mm, or about 5 mm. In some embodiments, the recession distance d can be 0 or about 0.

In some embodiments, the mating surface 372 can be curved to guide the flow of fuel. In some embodiments, the mating surface 372 can guide fuel toward the center of the MCC 360. In some embodiments, the mating surface 372 can include a soft surface or a gasket to prevent leaks. The lip 371 can be flat to adhere to the other surface of the MCC 360. In some embodiments, the lip 271 can be bonded to the outer surface of the MCC 360. In some embodiments, the lip 371 can fit to the outer surface of the MCC 360 without the use of an adhesive. For example, the lip 371 can fit to the outer surface of the MCC 360 via a latching or interlocking mechanism. In some embodiments, the shroud 370 can be coupled to the fuel injector 340 via machining the upper surface of the shroud 370 and the lower surface of the fuel injector 340 to fit together. In some embodiments, the lip 371 can be machined and the outer surface of the MCC 360 can be machined to fit together.

In some embodiments, the secondary opening 362 can receive an ignition device (e.g., a spark plug, an RCG). As shown, the secondary opening 362 is offset from the pole of the MCC 360. In some embodiments, the secondary opening 362 can be positioned at a latitude of at least about 30 degrees, at least about 35 degrees, at least about 40 degrees, at least about 45 degrees, at least about 50 degrees, at least about 55 degrees, at least about 60 degrees, at least about 65 degrees, at least about 70 degrees, or at least about 75 degrees. In some embodiments, the secondary opening 362 can be positioned at a latitude of no more than about 80 degrees, no more than about 75 degrees, no more than about 70 degrees, no more than about 65 degrees, no more than about 60 degrees, no more than about 55 degrees, no more than about 50 degrees, no more than about 45 degrees, no more than about 40 degrees, or no more than about 35 degrees. Combinations of the above-referenced latitudes are also possible (e.g., at least about 30 degrees and no more than about 80 degrees or at least about 40 degrees and no more than about 60 degrees), inclusive of all values and ranges therebetween. In some embodiments, the secondary opening 362 can be positioned at a latitude of about 30 degrees, about 35 degrees, about 40 degrees, about 45 degrees, about 50 degrees, about 55 degrees, about 60 degrees, about 65 degrees, about 70 degrees, about 75 degrees, or about 80 degrees.

In some embodiments, the secondary opening 362 can have a diameter of at least about 2 mm, at least about 3 mm, at least about 4 mm, at least about 5 mm, at least about 6 mm, at least about 7 mm, at least about 8 mm, at least about 9 mm, at least about 1 cm, at least about 1.5 cm, at least about 2 cm, at least about 2.5 cm, at least about 3 cm, at least about 3.5 cm, at least about 4 cm, or at least about 4.5 cm. In some embodiments, the secondary opening 362 can have a diameter of no more than about 5 cm, no more than about 4.5 cm, no more than about 4 cm, no more than about 3.5 cm, no more than about 3 cm, no more than about 2.5 cm, no more than about 2 cm, no more than about 1.5 cm, no more than about 1 cm, no more than about 9 mm, no more than about 8 mm, no more than about 7 mm, no more than about 6 mm, no more than about 5 mm, no more than about 4 mm, or no more than about 3 mm. Combinations of the above-referenced diameters are also possible (e.g., at least about 2 mm and no more than about 5 cm or at least about 5 mm and no more than about 1 cm), inclusive of all values and ranges therebetween. In some embodiments, the secondary opening 362 can have a diameter of about 2 mm, about 3 mm, about 4 mm, about 5 mm, about 6 mm, about 7 mm, about 8 mm, about 9 mm, about 1 cm, about 1.5 cm, about 2 cm, about 2.5 cm, about 3 cm, about 3.5 cm, about 4 cm, about 4.5 cm, or about 5 cm.

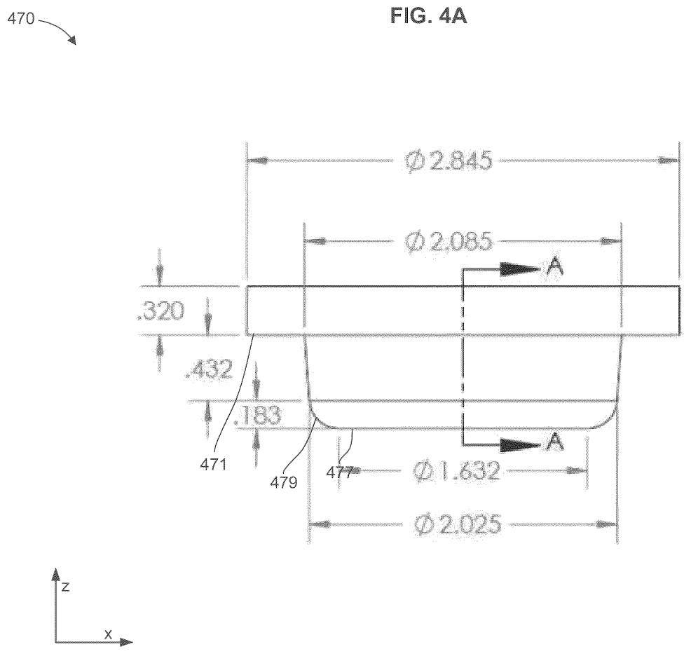

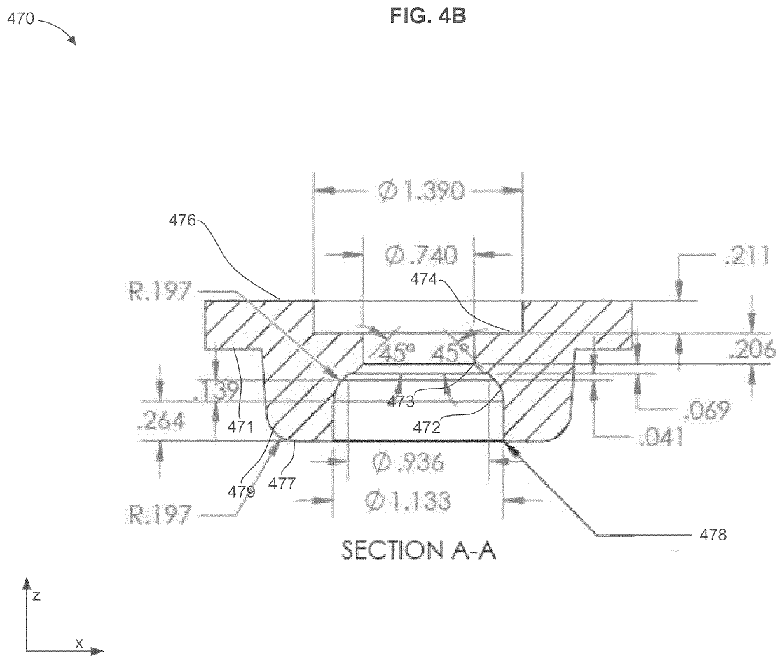

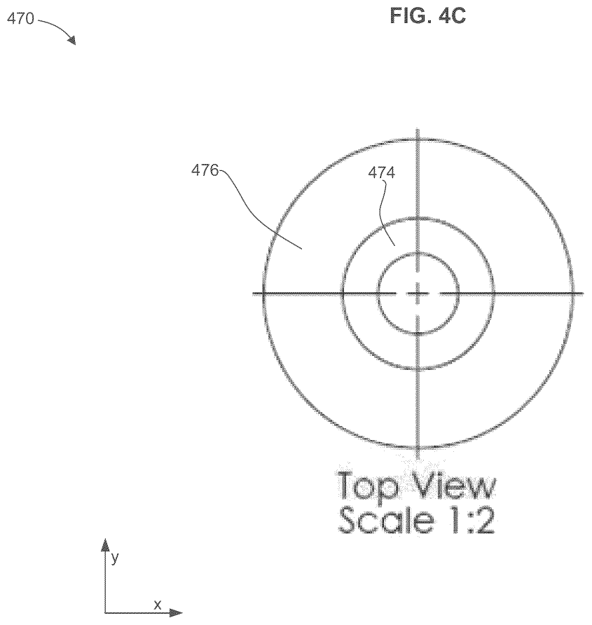

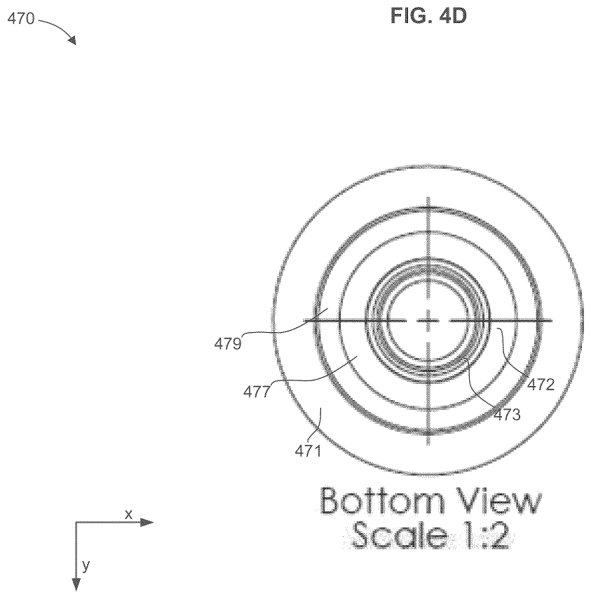

FIGS. 4A-4D show detailed views of a shroud 470, according to an embodiment. As shown, the shroud 470 includes a lip 471, a mating surface 472, an angled surface 473, an interior flat surface 474, a top surface 476, a leading surface 477, an edge break 478, and a fillet 479. In some embodiments, the shroud 470, the lip 471, and the mating surface 472 can be the same or substantially similar to the shroud 370, the lip 371, and the mating surface 372, as described above with reference to FIGS. 3A-3C. Thus, certain aspects of the shroud 470, the lip 471, and the mating surface 472 are not described in greater detail herein. FIG. 4A shows an exterior view of the shroud 470. FIG. 4B shows a cross-sectional view of the shroud 470. FIG. 4C shows a top view of the shroud 470. FIG. 4D shows a bottom view of the shroud 470. Axes are shown for clarity. Dimensions in FIGS. 4A-4D are shown for example only, and are not meant to be limiting.

The shroud 470 provides several combustion benefits. Without the shroud 470, the choke point would move into the MGAV (e.g., into the stem area) and lead to a lower flow velocity of the fuel that exits into the MCC. With the shroud 470 included in an engine, the choke point is at the bottom of the shroud 470, such that the smallest cross-sectional area of fuel flow is at the bottom of the shroud 470. By having the choke point be at the point at which the fuel exits into the MCC, the fuel exiting Into the MCC can have a greater velocity.

The lip 471 provides an outer surface of the shroud that can couple to an outer surface of an MCC. In some embodiments, the lip 471 can have a thickness (i.e., a dimension along the z-axis) of about 5 mm, about 6 mm, about 7 mm, about 8 mm, about 9 mm, about 10 mm, about 11 mm, about 12 mm, about 13 mm, about 14 mm, or about 15 mm, inclusive of all values and ranges therebetween. In some embodiments, the lip 471 can have a breadth beyond the leading surface 478 (i.e., a distance, by which the lip 471 extends beyond the leading surface 478 along the x-axis) of about 5 mm, about 6 mm, about 7 mm, about 8 mm, about 9 mm, about 10 mm, about 11 mm, about 12 mm, about 13 mm, about 14 mm, or about 15 mm, inclusive of all values and ranges therebetween.

The mating surface 472 acts as a surface for coupling the shroud 470 to an MGAV. The mating surface 472 is curved, such that fuel does not get caught in a dead zone. In some embodiments, the diameter of the mating surface 472 (i.e., the distance across the mating surface 472 along the x-axis) can be about 20 mm, about 21 mm, about 22 mm, about 23 mm, about 24 mm, about 25 mm, about 26 mm, about 27 mm, about 28 mm, about 29 mm, about 30 mm, about 31 mm, about 32 mm, about 33 mm, about 34 mm, about 35 mm, about 36 mm, about 37 mm, about 38 mm, about 39 mm, about 40 mm, about 41 mm, about 42 mm, about 43 mm, about 44 mm, about 45 mm, about 46 mm, about 47 mm, about 48 mm, about 49 mm, or about 50 mm, inclusive of all values and ranges therebetween. In some embodiments, the mating surface 472 can have a radius of curvature of about 100 μm, about 200 μm, about 300 μm, about 400 μm, about 500 μm, about 600 μm, about 700 μm, about 800 μm, about 900 μm, about 1 mm, about 1.5 mm, about 2 mm, about 2.5 mm, about 3 mm, about 3.5 mm, about 4 mm, about 4.5 mm, or about 5 mm, inclusive of all values and ranges therebetween.

The angled surface 473 is adjacent to the mating surface 472 and provides further surface for mating the shroud 470 to the MGAV. In some embodiments, the angled surface 473 can form an angle with the flow of fuel (i.e., with the z-axis) of about 30 degrees, about 35 degrees, about 40 degrees, about 45 degrees, about 50 degrees, about 55 degrees, or about 60 degrees, inclusive of all values and ranges therebetween.

The interior flat surface 474 is positioned on the top of the shroud 470 and forms a recessed region from the top surface 476. In some embodiments, the interior flat surface 474 can be recessed (i.e., positioned downward along the z-axis) from the top surface 476 by about 2 mm, about 2.5 mm, about 3 mm, about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, about 9.5 mm, or about 10 mm, inclusive of all values and ranges therebetween. In some embodiments, the distance from one edge of the interior flat surface 474 to the other end of the interior flat surface 474 (i.e., the diameter of the interior flat surface 474 along the x-axis) can be about 15 mm, about 20 mm, about 25 mm, about 30 mm, about 35 mm, about 40 mm, about 45 mm, or about 50 mm, inclusive of all values and ranges therebetween.

The top surface 476 couples to a fuel injector and forms a surface of the lip 471. In some embodiments, the top surface 476 can have a width (i.e., a dimension along the x-axis) of about 5 mm, about 10 mm, about 15 mm, about 20 mm, about 25 mm, about 30 mm, about 35 mm, about 40 mm, about 45 mm, or about 50 mm, inclusive of all values and ranges therebetween.

The leading surface 477 contacts the interior of the MCC. In some embodiments, the leading surface 477 can be flush or substantially flush with the interior surface of the MCC. In some embodiments, the leading surface 477 can protrude beyond the interior surface of the MCC. In some embodiments, the leading surface 477 can have a width (i.e., a dimension along the x-axis) or about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 21 mm, about 22 mm, about 23 mm, about 24 mm, or about 25 mm, inclusive of all values and ranges therebetween.

The edge break 478 is an edge adjacent to the leading surface 477 and the mating surface 472. In some embodiments, the mating surface 472 can be recessed from the leading surface 477 (i.e., in the z-direction). In some embodiments, the mating surface 472 can be recessed from the leading surface by about 3 mm, about 4 mm, about 5 mm, about 6 mm, about 7 mm, about 8 mm, about 9 mm, about 10 mm, about 11 mm, about 12 mm, about 13 mm, about 14 mm, or about 15 mm, inclusive of all values and ranges therebetween. As shown, the edge break 478 forms a 90-degree angle with the leading surface 477. In some embodiments, the edge break 478 can form an angle with the leading surface 477 of about 60 degrees, about 65 degrees, about 70 degrees, about 75 degrees, about 80 degrees, about 85 degrees, about 90 degrees, about 95 degrees, about 100 degrees, about 105 degrees, about 110 degrees, about 115 degrees, or about 120 degrees, inclusive of all values and ranges therebetween.

The fillet 479 provides a smooth transitional surface between the leading surface 477 and the lip 471. In some embodiments, the fillet 479 can have a radius of curvature of about 500 μm, about 600 μm, about 700 μm, about 800 μm, about 900 μm, about 1 mm, about 1.5 mm, about 2 mm, about 2.5 mm, about 3 mm, about 3.5 mm, about 4 mm, about 4.5 mm, or about 5 mm.

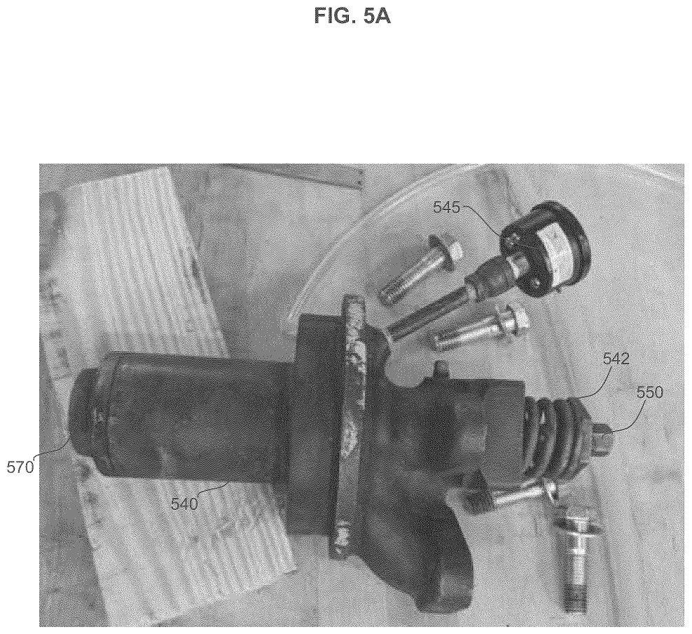

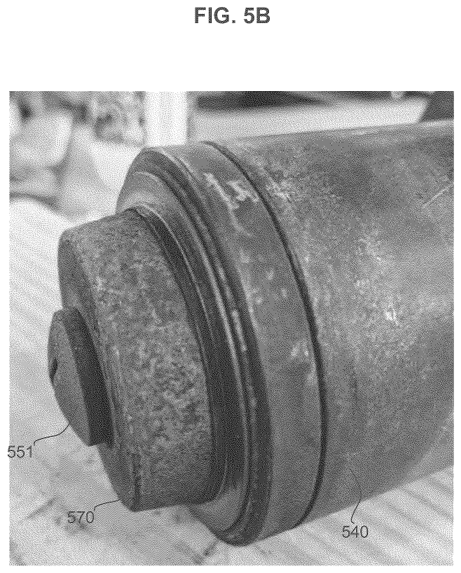

FIGS. 5A-5B are photographs of an exterior of a fuel injector 540, according to an embodiment. As shown, the fuel injector 540 includes a spring 542, a pressure gauge 545, an MGAV 550, and a shroud 570. In some embodiments, the fuel injector 540, the MGAV 550, and the shroud 570 can be the same or substantially similar to the fuel injector 140, the MGAV 150, and the shroud 170, as described above with reference to FIG. 1. Thus, certain aspects of the fuel injector 540, the MGAV 550, and the shroud 570 are not described in greater detail herein. FIG. 5A shows a perspective view of the fuel injector 540, while FIG. 5B shows a close detailed view of the connection between the shroud 570 and the distal end 551 of the MGAV 550.

The spring 542 contacts the MGAV 550 to keep a distal end 551 of the MGAV 550 in a closed position against the shroud 570. A cam (not shown) pushes against the MGAV 550 to compress the spring 542, such that fuel moves through the distal end 551 of the MGAV 550 via the shroud 570. The pressure gauge 545 measures the pressure inside the fuel injector 540.

In some embodiments, the spring 542 can exert a force of at least about 10 N, at least about 20 N, at least about 30 N, at least about 40 N, at least about 50 N, at least about 60 N, at least about 70 N, at least about 80 N, at least about 90 N, at least about 100 N, at least about 200 N, at least about 300 N, at least about 400 N, at least about 500 N, at least about 600 N, at least about 700 N, at least about 800 N, at least about 900 N, at least about 1,000 N, at least about 2,000 N, at least about 3,000 N, or at least about 4,000 N. In some embodiments, the spring 542 can exert a force of no more than about 5,000 N, no more than about 4,000 N, no more than about 3,000 N, no more than about 2,000 N, no more than about 1,000 N, no more than about 900 N, no more than about 800 N, no more than about 700 N, no more than about 600 N, no more than about 500 N, no more than about 400 N, no more than about 300 N, no more than about 200 N, no more than about 100 N, no more than about 90 N, no more than about 80 N, no more than about 70 N, no more than about 60 N, no more than about 50 N, no more than about 40 N, no more than about 30 N, no more than about 20 N. Combinations of the above-referenced forces are also possible (e.g., at least about 10 N and no more than about 5,000 N or at least about 50 N and no more than about 500 N), inclusive of all values and ranges therebetween. In some embodiments, the spring 542 can exert a force of about 10 N, about 20 N, about 30 N, about 40 N, about 50 N, about 60 N, about 70 N, about 80 N, about 90 N, about 100 N, about 200 N, about 300 N, about 400 N, about 500 N, about 600 N, about 700 N, about 800 N, about 900 N, about 1,000 N, about 2,000 N, about 3,000 N, about 4,000 N, or about 5,000 N.

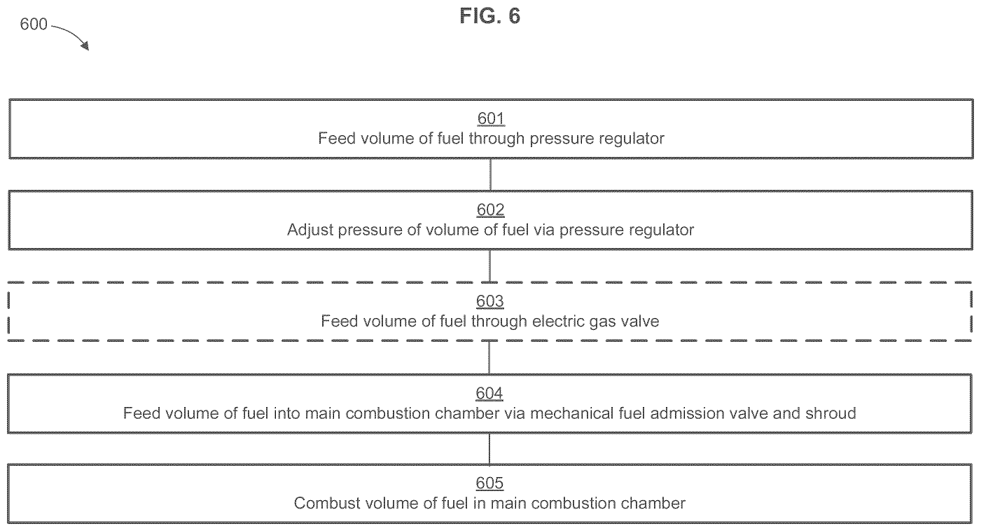

FIG. 6 is a flow diagram of a method 600 of fuel combustion, according to an embodiment. As shown, the method 600 includes feeding a volume of fuel through a pressure regulator at 601 and adjusting a pressure of the volume fuel via the pressure regulator at 602. The method 600 optionally includes feeding the volume of fuel through an electric gas valve at 603. The method 600 further includes feeding the volume of fuel into an MCC via an MGAV and a shroud at 604 and combusting the volume of fuel in the MCC at 605.

At 601, the method 600 includes feeding the volume of fuel through the pressure regulator. In some embodiments, the volume of fuel can be fed from a fuel supply. In some embodiments, the volume of fuel fed through the pressure regulator can include enough fuel for a single combustion cycle. In some embodiments, the volume of fuel fed through the pressure regulator can include enough fuel for multiple combustion cycles. In some embodiments, the volume of fuel fed through the pressure regulator can include an amount of fuel sufficient for about 1, about 2, about 3, about 4, about 5, about 6, about 7, about 8, about 9, about 10, or at least about 10 combustion cycles, inclusive of all values and ranges therebetween.

At 602, the method 600 includes adjusting the pressure of the volume of fuel via the pressure regulator. In some embodiments, the adjustment of the pressure can include increasing the pressure of the volume of fuel. In some embodiments, the adjustment of the pressure can include decreasing the pressure of the volume of fuel. In some embodiments, the pressure of the fuel can be adjusted to about 70 psi, about 75 psi, about 80 psi, about 85 psi, about 90 psi, about 95 psi, about 100 psi, about 105 psi, about 110 psi, about 115 psi, about 120 psi, about 125 psi, about 130 psi, about 135 psi, about 140 psi, about 145 psi, or about 150 psi, inclusive of all values and ranges therebetween. In some embodiments, adjusting the pressure of the fuel can include redirecting at least a portion of the fuel back to a fuel supply.

At 603, the fuel is optionally fed through an electric gas valve. In some embodiments, the electric gas valve can control the duration of the injection and the timing of the SOA. At 604, the method 600 includes feeding the volume of fuel into the MCC via the MGAV and the shroud. In some embodiments, the method 600 can include passing the fuel along a curved surface of the shroud to guide the flow of fuel. In some embodiments, the method 600 can include guiding the volume of fuel toward the center of the MCC.

At 605, the method 600 includes combusting the volume of fuel in the MCC. In some embodiments, the combustion can be via spark ignition, RCG-facilitated ignition, compression ignition, or any combination thereof. In some embodiments, at least about 10%, at least about 20%, at least about 30%, at least about 40%, at least about 50%, at least about 60%, at least about 70%, at least about 80%, at least about 90%, or at least about 95% of the volume of fuel can be combusted. In some embodiments, all or substantially all of the fuel can be combusted.

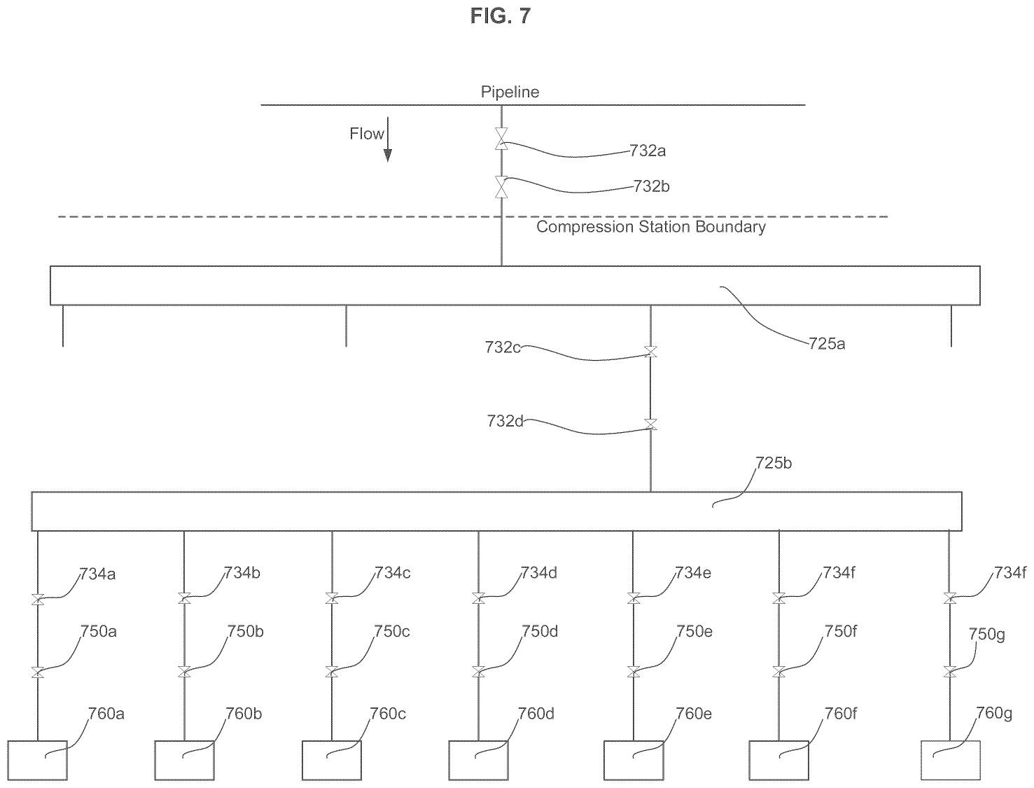

FIG. 7 is an illustration of interactions between pipelines and shrouded MGAV's, according to an embodiment. As shown, gas moves from a gas pipeline through a first cut regulator 732a and a second cut regulator 732b. The gas then exits the compression station and enters a first fuel header 725a which feeds to multiple engines. Each engine includes a final cut regulator 732c and a governor valve 732d. The gas then moves through a second heater 725b, where the gas splits into multiple flow paths, moving through multiple balancing valves 734a, 734b, 734c, 734d, 734e, 734f, 734g (collectively referred to as balancing valves 734) and shrouded MGAVs 750a, 750b, 750c, 750d, 750e, 750f, 750g (collectively referred to as MGAVs 750) before entering MCCs 760a, 760b, 760c, 760d, 760e, 760f, 760g (collectively referred to as MCCs 760).

The first cut regulator 732a reduces the pressure of the gas to about 2,000 kPa, about 2,100 kPa, about 2,200 kPa, about 2,300 kPa, about 2,400 kPa, about 2,500 kPa, about 2,600 kPa, about 2,700 kPa, about 2,800 kPa, about 2,900 kPa, about 3,000 kPa, about 3,100 kPa, about 3,200 kPa, about 3,300 kPa, about 3,400 kPa, about 3,500 kPa, about 3,600 kPa, about 3,700 kPa, about 3,800 kPa, about 3,900 kPa, or about 4,000 kPa, inclusive of all values and ranges therebetween. The second cut regulator 732b reduces the pressure of the gas to about 400 kPa, about 450 kPa, about 500 kPa, about 550 kPa, about 600 kPa, about 650 kPa, about 700 kPa, about 750 kPa, about 800 kPa, about 850 kPa, or about 900 kPa, inclusive of all values and ranges therebetween. In some embodiments, the final cut regulator 732c reduces the pressure of the gas to about 200 kPa, about 250 kPa, about 300 kPa, about 350 kPa, about 400 kPa, about 450 kPa, or about 500 kPa, inclusive of all values and ranges therebetween. In some embodiments, the balancing valves 734 can auto-balance the pressures between each of the fuel lines.

### Advanced Engine Ignition

In some embodiments, advanced engine ignition can be implemented, e.g., in an existing engine. Advanced engine ignition may include the additional of one or more PCCs or RCGs.

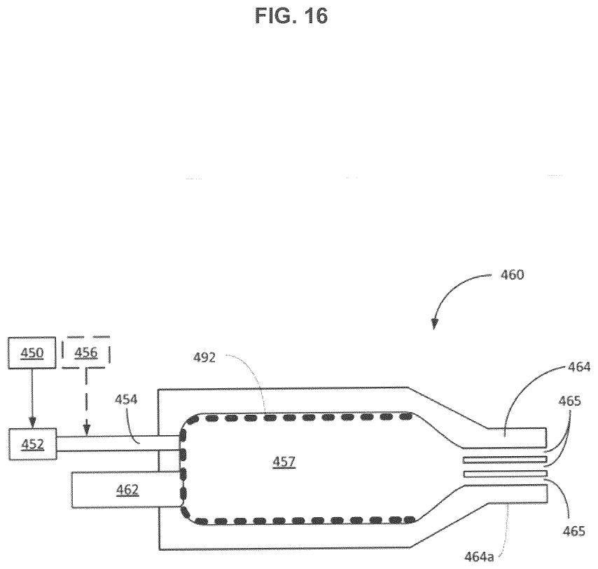

In some embodiments, an RCG device can include a housing defining a radical chemicals generator volume (RCGv), a spark or ignition device, and a fuel-delivery control device that can be directly or indirectly mounted to the housing. FIG. 16 depicts an example RCG 460, according to some embodiments. The RCG 460 can have a housing that defines an RCGv or chamber 457, a spark device 462, and a fuel-delivery control device 452 (e.g., an electronic check valve or a mechanical fuel metering device or valve), which is coupled via a passageway 454 to the housing of the RCG 460. The RCG includes a nozzle 464, which can be configured to couple to a head of an internal combustion engine (e.g., head 116, 216). For example, the nozzle 464 can have an attachment mechanism 464a that enables the nozzle 464 to attach to the head. In some embodiments, the attachment mechanism 464a can be a threaded surface that can screw into a threaded port or opening on the head for receiving the nozzle 464. The threaded port on the head can be, for example, a pre-existing opening in the head that was previously used to receive one or more other components of the internal combustion engine (e.g., a PCC, a spark plug, etc.) that may no longer be required with the addition of the RCG 460 to the engine.

In some embodiments, the RCG attachment mechanism 464a can include one or more flanges for mounting the RCG to the head.

Referring to FIG. 16, a fuel source 450 can be coupled to the RCG 460, e.g., via passageway 454. The fuel source 450 can be structurally and/or functionally similar to fuel source 150 described above. The fuel-delivery control device 452, which may be, for example, a mechanical or electronic check valve, can control the rate and/or amount of fuel delivered into the RCGv 457 during each combustion cycle. The mixture of fuel-air charge in the RCGv 457 (e.g., from fuel delivered by fuel source 450 and/or fuel or air forced into the RCG from a MCC during a combustion cycle) can be ignited using the spark device 462 to produce burning combustion products inside the RCGv. These combustion products, as described below, can be quenched by the nozzle 464 to produce RS. In some embodiments, the RCG 460 can optionally be coupled to an air source 456 that delivers pressurized air into the RCGv 457. The pressurized air can increase air-fuel ratio within the RCGv 457 to aid in combustion within the RCGv 457.

The nozzle 464 can include one or more orifices or passageways 465, e.g., such as one or more orifices or passageways 465 that form part of a nozzle. The passageways 465 of the nozzle 464 are configured to interrupt a combustion process that occurs in the RCGv by quenching the flame of burning combustion products from the RCGv before it enters a MCC of an internal combustion engine. The quenching occurs as the combustion products from the RCGv expand and pass through the nozzle passageways 464 and produces a hot jet of partial combustion products. The nozzle 464 can be designed with a quenching distance (e.g., distance from the nozzle 464 exit into the MCC before the hot jet ignites the MCC fuel-air charge) that is several times the length of the nozzle 464, which can position the ignition and initiation of the combustion event at multiple locations throughout the MCC.

Suitable examples of PCCs and RCGs are described in U.S. patent application Ser. No. 17/680,074, filed Feb. 24, 2022, titled “Systems, Apparatus, and Methods for Inducing Enhanced Radical Ignition in Internal Combustion Engines Using a Radical Chemicals Generator,” published as U.S. Patent Application Publication No. 2022/0178300, the disclosure of which is incorporated herein by reference in its entirety.

### Testing Data

MGAV vs. sMGAV Tests

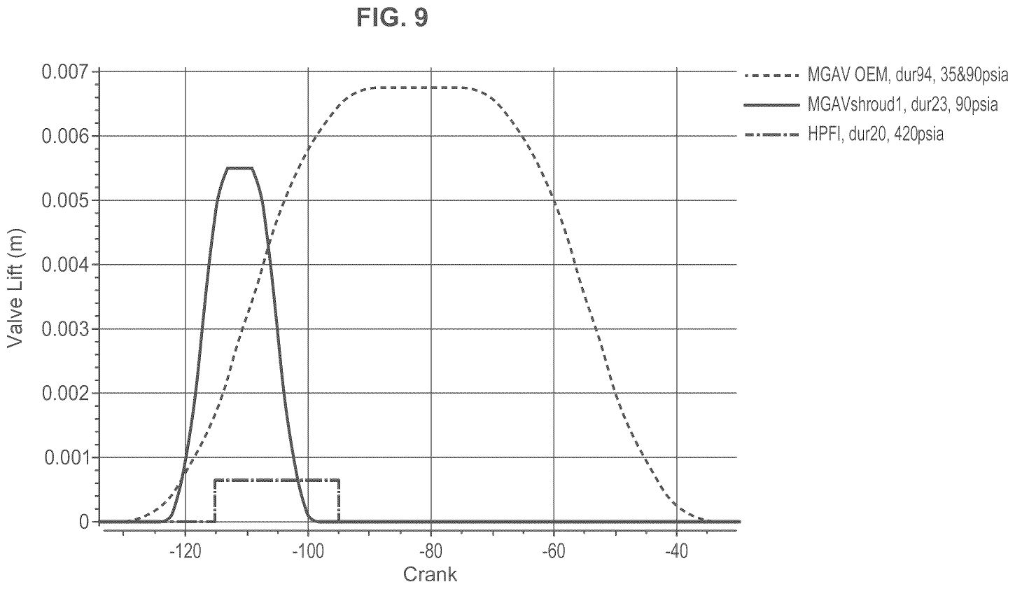

FIG. 9 shows the sMGAV profile with a 23 CAD opening duration opening to 5.5 mm in comparison to a MGAV OEM profile with a 94 CAD duration, opening to a maximum of 6.6 mm. An HPFI scheme is shown for reference, which opens for 20 degrees to a maximum lift of 0.6 mm. As shown, the shrouded short-duration MGAV delivers just as much fuel in a shorter fuel delivery window due to a greater pressure applied to the fuel.

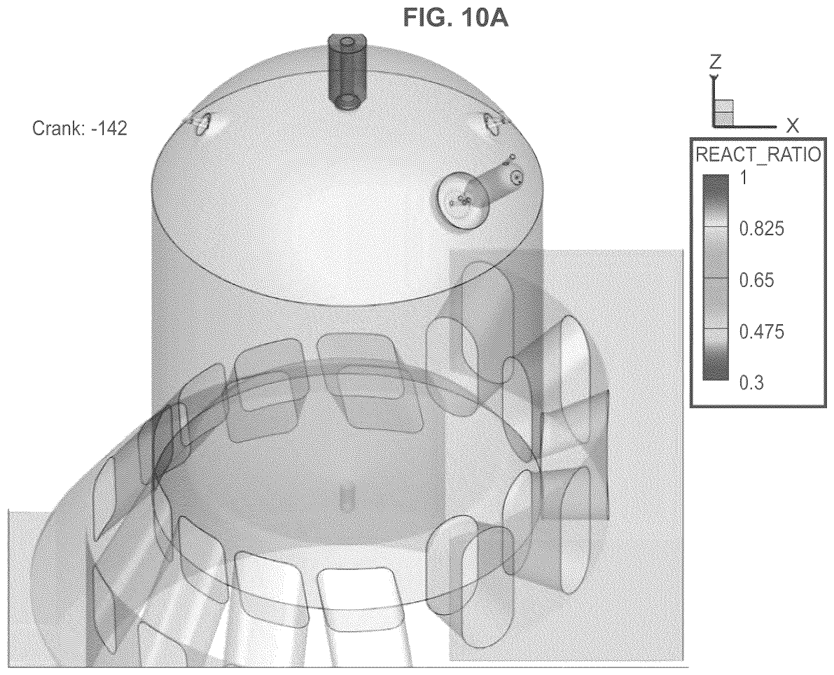

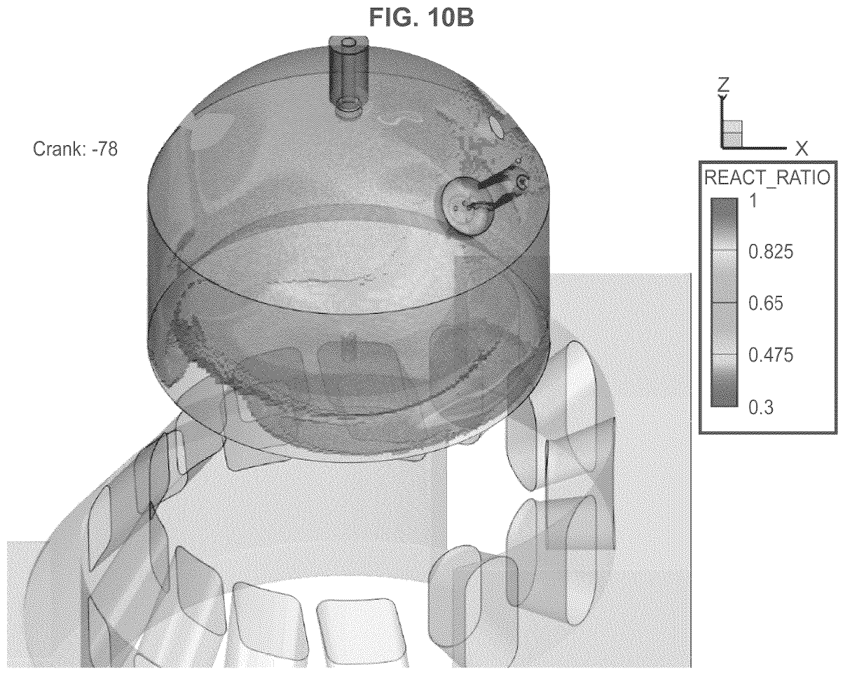

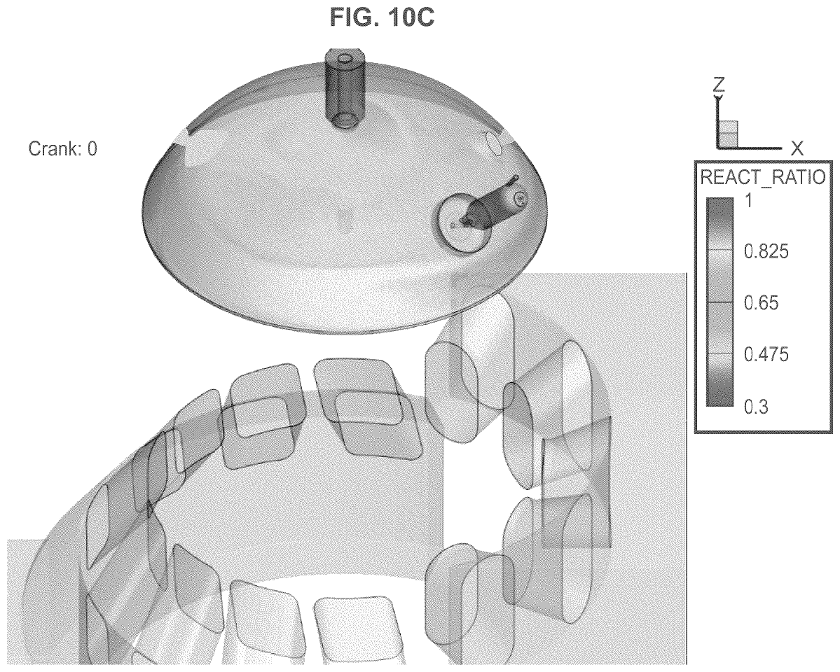

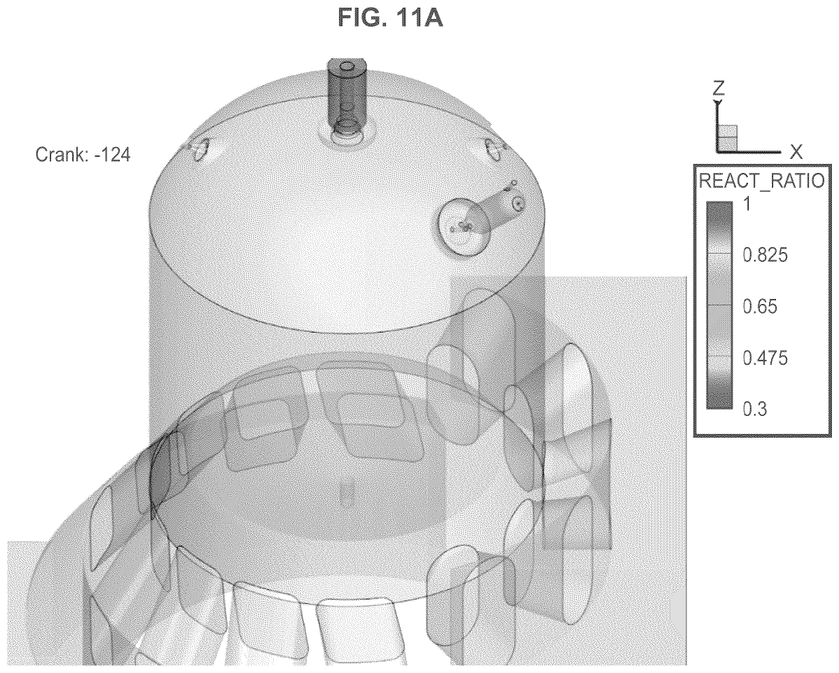

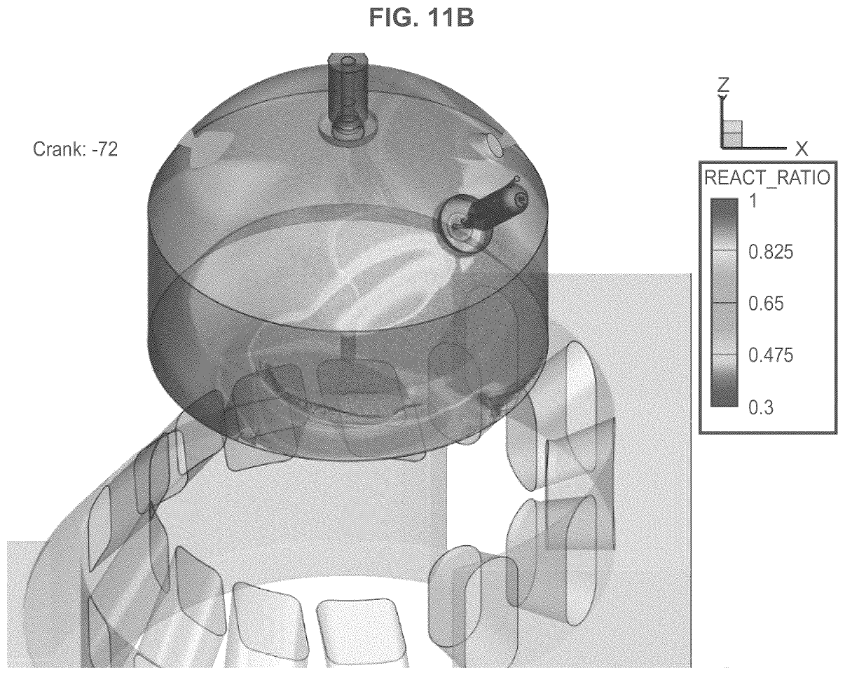

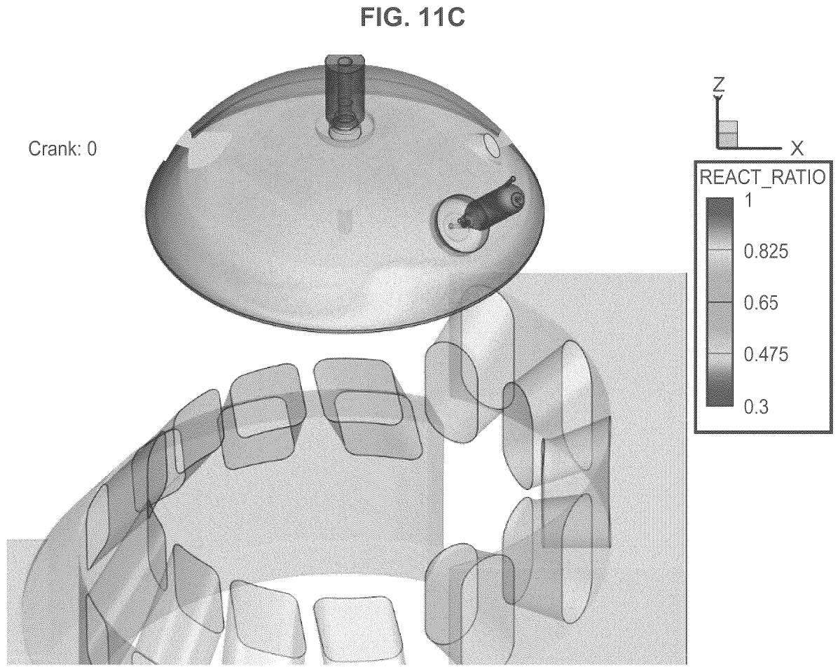

FIGS. 10A-10C are combustion profiles of an MGAV scheme, according to an embodiment. FIG. 10A shows the engine at a crank angle of 142 CAD BTDC. FIG. 10B shows the engine at a crank angle of 78 CAD BTC. FIG. 10C shows the engine at TDC. As shown, the fuel reacts as the piston approaches TDC. The color-mapped area in FIGS. 11A-11C represents the combustion area, which shrinks as the piston approaches TDC.

FIGS. 11A-11C are combustion profiles of an sMGAV scheme, according to an embodiment. FIG. 11A shows the engine at a crank angle of 124 CAD BTDC. FIG. 11B shows the engine at a crank angle of 72 CAD BTC. FIG. 11C shows the engine at TDC. As shown, the fuel reacts as the piston approaches TDC.

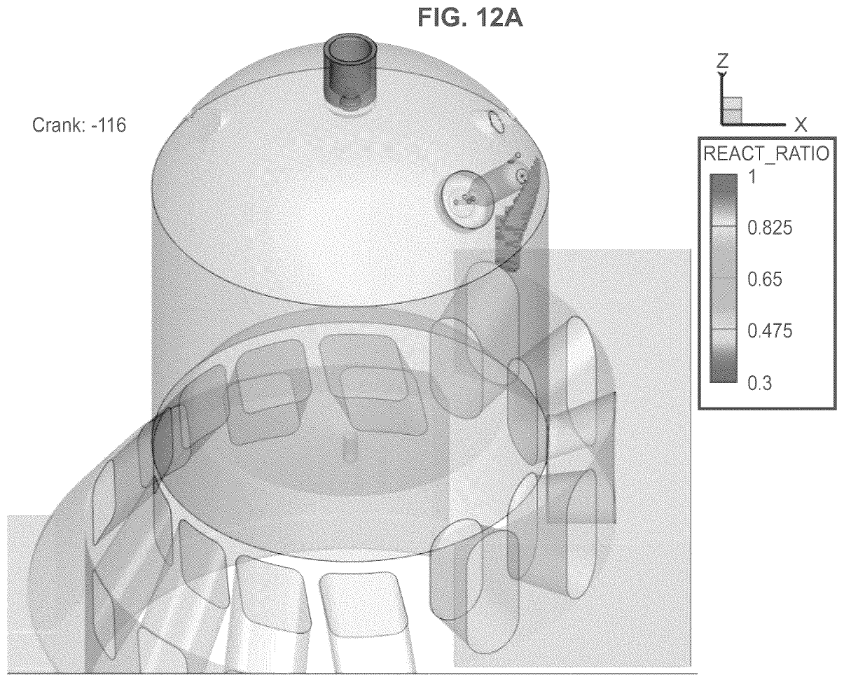

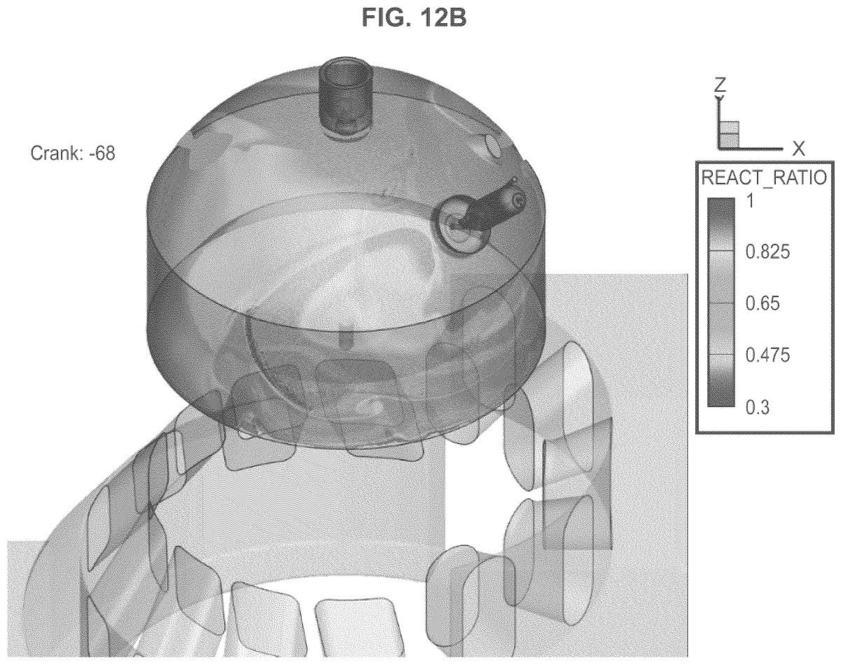

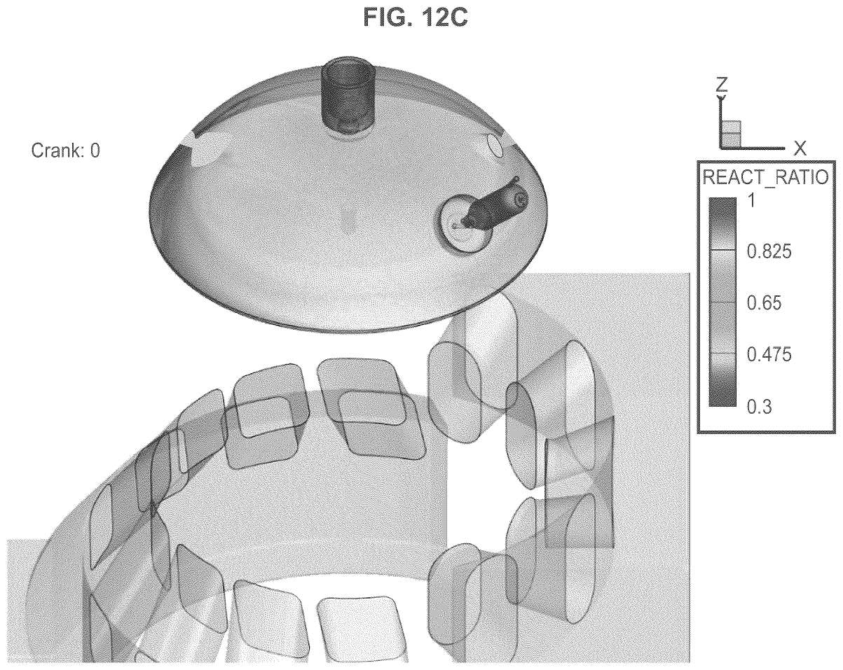

FIGS. 12A-12C are combustion profiles of an sMGAV scheme, according to an embodiment. FIG. 12A shows the engine at a crank angle of 116 CAD BTDC. FIG. 12B shows the engine at a crank angle of 68 CAD BTC. FIG. 12C shows the engine at TDC. As shown, the fuel reacts as the piston approaches TDC.

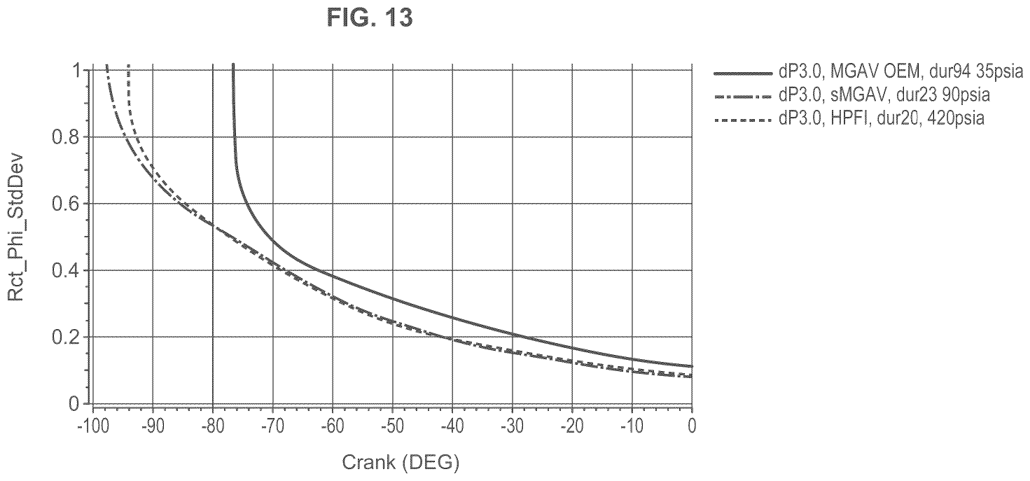

FIG. 13 shows comparisons of equivalence ratios at different crank angles, based on different injection pressures and intake valve opening times. As shown, the sMGAV scheme with a short valve opening duration and the HPFI scheme with the short valve opening duration yield lower air-fuel ratios than MGAV with a longer valve opening duration.

NOₓ and Methane Reduction Tests

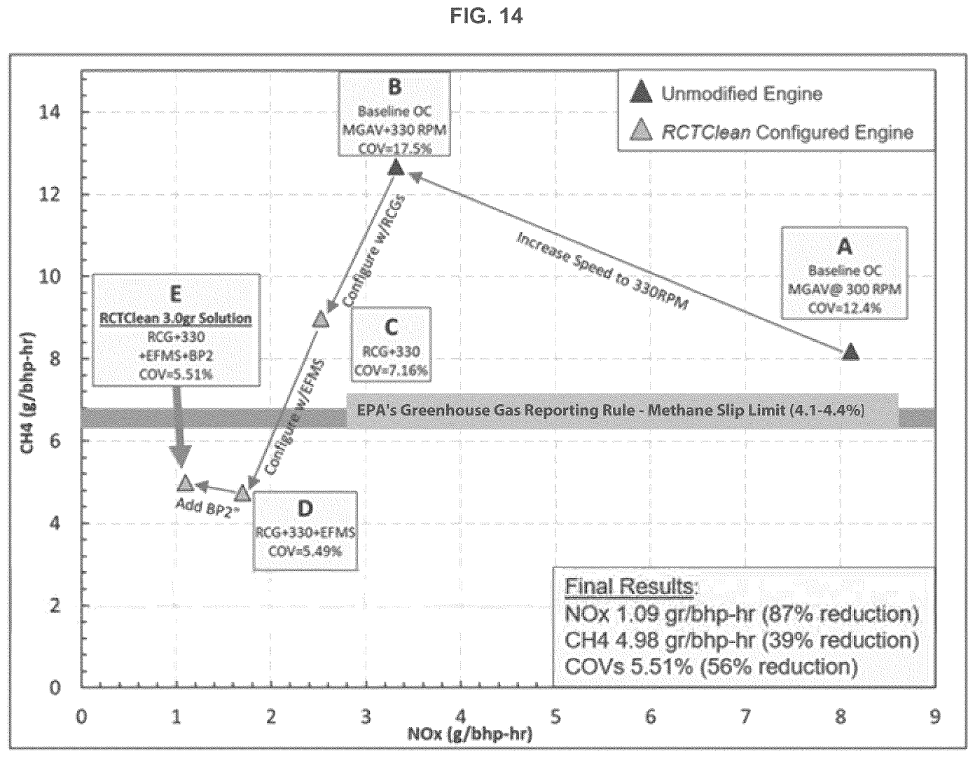

Preliminary testing on a GMV 4-cylinder engine with a configuration of components 1-6 described above have demonstrated NOₓ reduction from between 8.2 and 10.0 gr/bhp-hr for the unmodified engine to between 0.8 and 2.5 gr/bhp-hr with components 1-6. FIG. 14 depicts data from further testing starting with a baseline engine with a standard low-pressure mechanical gas admission valve (MGAV) and an engine speed of 300 rpm. For example, as depicted in FIG. 14, a baseline engine with a MGAV and 300 rpm produced high NOₓ emission levels (e.g., over 8 gr/bhp-hr). Increasing the air-to-fuel ratio (e.g., by increasing engine speed to 330 RPM) reduces NOₓ from 8.0 gr/bhp/hr down to about 3.3 gr/bhp-hr but increases the methane emission from 8.0 gr/bhp-hr to greater than 12.8 gr/bhp-hr. Adding an RCG to each cylinder to the engine at this operating condition reduces both NOₓ and methane emissions to about 2.5 and 9.0 gr/bhp-hr, respectively. Then, combining the increase in air-to-fuel ratio, RCG, 2″ Hg of back pressure, and EFMS provides for both low NOₓ and methane emissions. Finally, adding 4″ Hg of back pressure reduces NOₓ to less than 1 gr/bhp-hr but does not further reduce methane emissions. Alternatively, adding an EFMS alone reduces methane to less than 5 gr/bhp-hr but does not reduce NOₓ by much.

Further testing and use of high-performance cloud-based computational simulation will be used to improve and optimize the design of RCG and EFMS components for specific engines.

To evaluate the effectiveness of EFMS modifications, simulations in Converge computational fluid dynamics (CFD) software were conducted that focused on standard deviation equivalence ratio (SDER), which is a suitable measure for evaluating the uniformity of fuel-air mixing in the MCC. The lower the SDER, the better the mixing. The MGAV mixing SDER value of 0.16 represents a stratified/non-homogeneous fuel-air mixing.

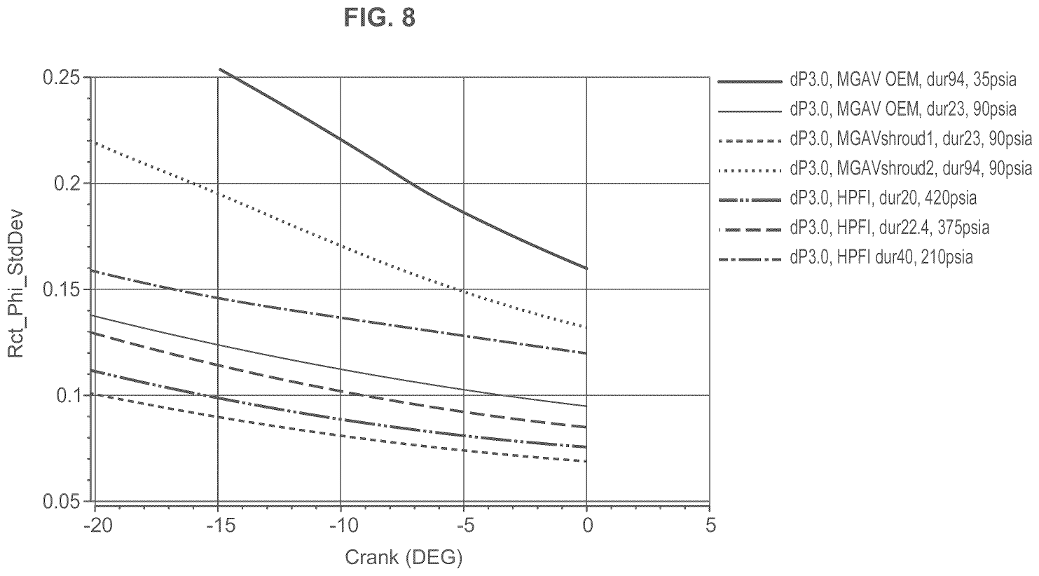

Preliminary simulation results are shown in FIG. 8. The simulation results are labeled in FIG. 8:
1) MGAV
2) EFMS
3) HPFI

In the plot in FIG. 8, a lower ending value (which represents TDC when combustion begins) is indicative of better mixing.

The simulation results above show that the SDER for the three cases above are:
1) MGAV—0.16
2) EFMS—0.07
3) HPFI—0.075

The simulation results demonstrate that the EFMS results in mixing in the MCC that is as thorough or more thorough than HPFI. An EFMS upgrade is expected to cost significantly less than HPFI.

FIG. 14 depicts a graph showing the NOₓ and CH₄ emissions of an engine with one or more modifications, according to embodiments. As shown, baseline conditions with MGAV and 300 RPM leads to a COV of 12.4% (A). Baseline conditions with MGAV and 330 RPM leads to COV of 17.5% (B). An RCG with 330 RPM leads to COV of 7.16% (D), an RCG and EFMS with 330 rpm leads to COV of 5.49% (D). An RCG with EFMS, a backpressure (BP2), and 330 RPM leads to COV of 5.51% (E). Points D and E are lower than EPA's Greenhouse Gas Reporting Rule proposed slip limit.

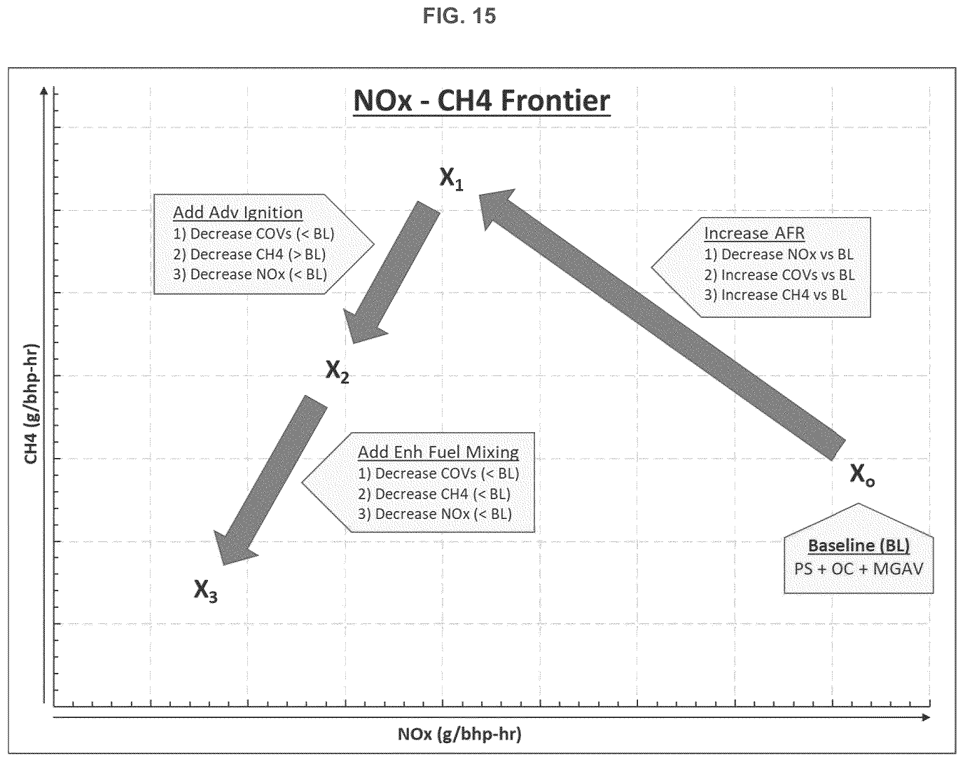

FIG. 15 depicts a graph showing the NOₓ and CH₄ emissions of an engine with one or more modifications, according to embodiments. As shown, the engine starts in a baseline operating scheme (X₀), i.e., a piston-scavenged engine with a MGAV. The air-fuel ratio is then increased (X₁), which decreases NOₓ emissions, increases COV emissions, and increases CH₄ emissions. The engine including advanced ignition (X₂), where a PCC or RCG has been added, decreases COV, CH₄ emissions, and NOₓ emissions. The addition of enhanced fuel mixing (X₃), e.g., with a sMGAV (and adjustment of duration and/or pressure) or HPFI, decreases COV emissions, CH₄ emissions, and NOₓ emissions.

An engine with a configuration including EFMS, RCG, a speed increase, and a BPV has been shown to achieve NOₓ emissions of less than the GNP 3.0-gram level while also reducing methane emissions 40-50% below the baseline (unmodified) level. This reduced NOₓ level and reduced CH₄ level can be achieved without the addition of costly turbocharging and HPFI.

Table 1 shows changes in various parameters between a baseline GMV engine and a modified engine with 1) increased A/F ratio with increased speed and back pressure valve; 2) RCGs; and 3) an enhanced fuel mixing system. Table 1 depicts changes in emissions in a GMV 4-cylinder engine, without any changes (baseline) compared to with the addition of the RCG and increasing engine speed from 300 RPM to 330 RPM of the RCTClean solution (RCTClean 3.0 gr solution). As shown, both NOₓ and CH₄ emissions decrease with the RCTClean solution.

TABLE 1
Changes in parameters between baseline
GMV engine and modified engines

| | Baseline | RCTClean | Change |
|---|---|---|---|
| GMV-4 Parameters | GMV | 3.0 gr | (+/− %) |
| Load (HP) | 480 | 492.6 | N/A |
| AMP (“Hg) | 9.45 | 11.81 | N/A |
| AMT (° F.) | 129.7 | 138.8 | N/A |
| NOₓ (gr/bhp-hr) | 8.10 | 1.09 | −86.5% |
| CO (gr/bhp-hr) | 5.92 | 3.54 | −40.2% |
| THC (gr/bhp-hr) | 10.73 | 6.47 | −39.7% |
| VOC (gr/bhp-hr) | 1.46 | 1.51 | +3.4% |
| CH₄ (gr/bhp-hr) | 8.18 | 4.98 | −39.1% |
| CH₂O (gr/bhp-hr) | 1.29 | 1.32 | +2.3% |
| BSFC (BTU/bhp-hr) | 9145.70 | 9258.02 | +1.2% |
| Misfires (%) | 0.225 | 0.0 | −100% |
| COV (%) | 12.4 | 5.51 | −55.6% |

Table 2 shows a comparison of engines with commercially available upgrades, compared to shrouded MGAV upgrades described herein. As shown, the upgrades described herein perform better in terms of reduced methane and CO2 emissions.

TABLE 2
Comparisons of emissions from commercially available improvements
as compared to improvements described herein

| | Current OEM | |
|---|---|---|
| | Upgrades PCC + | RCTClean |
| | Turbo Upgrade only | Upgrade |
| NOₓ (gr/bhp-hr) | <<3.0 | <<3.0 |
| CO (gr/bhp-hr) | Reduced | Reduced |
| CO₂ₑ (gr/bhp-hr) | Increased | Reduced |
| Methane (gr/bhp-hr) | Increased | Reduced |
| COVs | Reduced | Reduced |
| Heat Rate | Reduced | Reduced |

### Abbreviations and Parameters

The following abbreviations and parameter definitions apply, as used herein:
ATDC=After Top Dead Center
BDC=Bottom Dead Center BTDC=Before Top Dead Center CAD=Crank AngleDegrees
CFD=Computational Fluid Dynamics ECR=Effective Compression Ratio
EFMS=Electronic Fuel Management System GMV=Ground Mobility Vehicle
HPFI=High Pressure Injection=an aftermarket kit installed that utilizes high pressure gas to achieve enhanced mixing
MCC=Main Combustion Chamber
MGAV=Mechanical Gas Admission Valve or Mechanical Fuel Admission Valve OEM=Original Equipment Manufacturer
RCG=Radical Chemical Generator=a device to initiate combustion without flame SDER=Standard Deviation Equivalence Ratio
sMGAV=Shrouded Mechanical Gas Admission Valve
SOA=Start of Admission
TDC=Top Dead Center=180 crank angle degrees after Bottom Dead Center

Unless otherwise noted, pressures described herein should be understood as pressures above atmospheric pressure (e.g., gauge pressures).

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of cylinders, the set of cylinders can be considered as one cylinder with multiple portions, or the set of cylinders can be considered as multiple, distinct cylinders. Additionally, for example, when referring to a plurality of engines, the plurality of engines can be considered as multiple, distinct engines or as one engine with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

Also, various concepts may be embodied as one or more methods. The acts performed as part of the methods may be ordered in any suitable way. Accordingly, embodiments may be constructed in which acts are performed in an order different than described, which may include performing some acts simultaneously, even though shown as sequential acts in illustrative embodiments.

1. An engine, comprising: a fuel supply;
a pressure regulator;
an electric gas valve configured to control fuel flow;
a fuel injector, the fuel injector including a mechanical fuel admission valve and a shroud;
a cam configured to control the mechanical fuel admission valve; and
a main combustion chamber including a piston and an outer surface configured to contact the shroud of the fuel injector,
wherein the shroud includes a rounded surface configured to direct a flow of fuel toward a geometric center of the piston.

2. The engine of claim 1, wherein the mechanical fuel admission valve has an enlarged distal end configured to contact a surface of the shroud.

3. The engine of claim 1, further comprising:
an opening integrated into a head of the combustion chamber, the opening configured to house at least one of a spark plug or a radical chemical generator.

4. The engine of claim 1, wherein the shroud includes a lip configured to rest on the outer surface of the main combustion chamber.

5. The engine of claim 1, wherein the shroud further includes an angled surface adjacent to the rounded surface, the angled surface oriented, such that an upper end of the angled surface has a smaller diameter than a lower end of the angled surface.

6. The engine of claim 1, wherein the cam is configured to open the mechanical fuel admission valve for no more than about 30 crank angle degrees.

7. A method comprising:
feeding a volume of fuel through a pressure regulator;
adjusting the pressure of the volume of fuel via a pressure regulator;
feeding the volume of fuel into a main combustion chamber via a mechanical fuel admission valve including a shroud, the main combustion chamber including a piston, the shroud having a curved surface and configured to a flow of fuel toward a geometric center of the piston; and
combusting the volume of fuel in the main combustion chamber.

8. The method of claim 7, wherein movement of the mechanical fuel admission valve is influenced by a cam, the mechanical fuel admission valve is open for less than about 50 crank angle degrees.

9. The method of claim 8, wherein movement of the mechanical fuel admission valve is influenced by a cam, the mechanical fuel admission valve is open for less than about 30 crank angle degrees.

10. The method of claim 9, wherein movement of the mechanical fuel admission valve is influenced by a cam, the mechanical fuel admission valve is open for a time period between about 20 crank angle degrees and about 30 crank angle degrees.

11. The method of claim 7, wherein feeding the volume of fuel into the main combustion chamber is such that a start of admission is at about 115 to about 120 CAD BTDC.

12. The method of claim 7, wherein the start of admission is adjusted, such that no fuel slip occurs via exhaust ports before the exhaust ports are fully closed.

13. An engine, comprising: a fuel supply;
a pressure regulator;
a fuel injector, the fuel injector including a mechanical fuel admission valve and a shroud;
a cam configured to control the mechanical fuel admission valve;
a main combustion chamber including a piston and an outer surface configured to contact the shroud of the fuel injector; and
a radical chemical generator integrated into the main combustion chamber.

14. The engine of claim 13, wherein the mechanical fuel admission valve has an enlarged distal end configured to contact a surface of the shroud.

15. The engine of claim 13, wherein the shroud includes a lip configured to rest on the outer surface of the main combustion chamber.

16. The engine of claim 13, wherein the cam is configured to open the mechanical fuel admission valve for no more than about 30 crank angle degrees.

17. The engine of claim 13, further comprising:
an electric gas valve configured to control fuel flow.

18. The engine of claim 13, wherein the engine has a nitrogen oxides (NOₓ) emission rate of less than 3.0 gr/bhp-hr.

19. The engine of claim 13, wherein the pressure regulator includes a back pressure valve.

20. The engine of claim 19, wherein the engine has a methane emission rate of about 40% to about 50% less than an equivalent engine without a radical chemical generator, a back pressure valve
